(19) United States
(12) Patent Application Publication
(10) Pub. No.: US 2016/0023539 A1
(43) Pub. Date: Jan. 28, 2016

(54) ENERGY RECOVERY IN AIR CONDITIONING AND OTHER ENERGY PRODUCING SYSTEMS

(71) Applicant: ENERGY RECOVERY TECHNOLOGY, INC., Pensacola, FL (US)

(72) Inventor: Tommy A. JOHNSON, SR., Pensacola, FL (US)

(21) Appl. No.: 14/539,660

(22) Filed: Nov. 12, 2014

Related U.S. Application Data
(60) Provisional application No. 62/028,528, filed on Jul. 24, 2014.
(60) Provisional application No. 62/045,882, filed on Sep. 4, 2014.

(51) Int. Cl. B60H 1/32; B60H 1/00

(52) U.S. Cl. CPC B60H 1/3227; B60H 1/005

(57) ABSTRACT

An energy recovery system in a principal cooling system, which includes a canister mountable on a refrigerant line, the refrigerant line producing cold to an exterior of the refrigerant line, the canister comprising a body portion for encasing at least a portion of the refrigerant line with a fluid flow channel through the body of the canister for flowing a refrigerant mixture therethrough, the refrigerant mixture being cooled by the cold produced by refrigerant line, so that when the refrigerant mixture exits the canister, the refrigerant mixture is colder than when it entered the canister and can be circulated to another system that can utilize the cooled refrigerant mixture. In a second embodiment of the system, an enlarged canister encases a portion of a compressor, and a refrigerant mixture flows through the canister to receive heat from the compressor to cool down the compressor. In a third embodiment, an enlarged canister encases the outer wall of a tank, such as a transformer, and a refrigerant mixture flows through the canister to receive heat from the transformer in order to increase the longevity of the transformer. In both the second and third embodiments, the heated fluid would then flow through a heat exchanger, such as a radiator, to cool the fluid before it is returned to the enlarged canister. In additional embodiments, multiple canister devices are utilized to cool water in a water fountain line, and on the high side and low side lines in an air conditioning system.

### CROSS-REFERENCE TO RELATED APPLICATIONS

Priority of U.S. Provisional Patent Application Ser. No. 62/028,528, filed on 24 Jul. 2014, and U.S. Provisional Patent Application Ser. No. 62/045,882, filed on 4 Sep. 2014, each of which is incorporated herein by reference thereto, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The system of the present invention relates to air conditioning systems. More particularly, the present invention relates to an energy recovery system, which includes a canister device which may be installed on the high side or low side lines of an air conditioning system to recover additional cooling power to the system or to a secondary cooling system, depending on the needs. The present invention also relates to an energy recovery system which is capable of cooling down a compressor in an air conditioning system and cooling down a transformer to extend the life of the transformer. The present invention also relates to the energy recovery system disclosed herein whereby multiple canister devices are utilized to cool water in a water fountain line and the high side and low side lines in an air conditioning system. There is also provided an embodiment with the canister modified to include multiple double helix fluid flow channels within the canister body.

2. General Background of the Invention

In the conventional air conditioning systems known in the art, many are used for commercial and residential dwellings and utilize an outside compressor unit which houses a compressor motor for cooling a refrigerant fluid, such as Freon® (a registered trademark owned by DU PONT DE NEMOURS AND COMPANY CORPORATION). The refrigerant cooled by the compressor travels through a low side line into the residential or commercial building where the cooled refrigerant is routed through a first series of coils to cool air blown through the coils by a fan and is then delivered through a series of ducts throughout the structure. The air is then recirculated into the coils for re-cooling and re-distribution through the structure. The refrigerant is recirculated to the outside via a high side line where it is run through a second series of coils to be cooled by air drawn through the coils and back into the compressor to be re-cooled and recirculated.

It is generally known in the air conditioning art that the reduction of energy can be achieved in an air conditioning system by improving the efficiency of the coils ability to quickly dissipate heat. For example, the present inventor has obtained U.S. Pat. No. 6,619,059 which is a method and apparatus for cooling air conditioning systems condensing coils utilizing an air filter pad constructed of glass fibers with self-contained perforated water capillary tube allowing moisture to permeate the filter pads. A second patent issued to the present inventor, U.S. Pat. No. 7,080,519 which is an improvement from the system in the '059 patent, and teaches a method and apparatus for cooling air conditioning systems, condensing coils utilizing an air filter pad made of glass fibers. In yet a third patent issued to the present inventor, U.S. Pat. No. 7,658,183 entitled “Engine Air Intake and Fuel Chilling System and Method”, there is disclosed a combustion engine intake air cooler system that utilizes the vehicle air conditioning system to chill the engine intake air supply by conducting latent heat from the intake air passing through the intake air ducts using an external tubular induction coil in contact with and surrounding the air intake duct and connected to the vehicle air conditioning refrigeration system. All of these three patented systems by the present inventor attempt to provide a secondary means for cooling the air through an air conditioning system beyond what is normally done in a routine state of the art air conditioning system.

Another situation which needs addressing is the need to reduce the temperature of a compressor component in an air-conditioning system, which would allow the compressor to use less electrical power and extend the life of the compressor. Likewise, it has been found that it would be beneficial to be able to cool down the temperature of a transformer, of the type which supplies electrical power to homes and businesses, and in doing so reducing the number of transformers which “blow” due to overheating, and in doing so, extending the life of the transformer.

### BRIEF SUMMARY OF THE INVENTION

The apparatus of the present invention solves the problems confronted in the art in a simple and straightforward manner.

The first preferred embodiment of the system of the present invention provides an energy recovery technology, which includes a canister, constructed preferably of plastic, which is capable of encasing the low side line exiting the compressor and carrying cooled refrigerant fluid. The canister further provides a fluid intake port on the canister and a fluid outflow port on the canister. A second volume of refrigerant, preferably antifreeze mixed with water, is pumped into the intake port and through a circular pathway constructed in the body of the canister so that the circulation of the refrigerant/water around the low side line which is carrying cooled refrigerant fluid, reduces the temperature of the coolant or refrigerant/water mixture to around the same temperature of the cooled refrigerant. For example, if the cooled refrigerant fluid in the low side line is in the neighborhood of 38 degrees Fahrenheit (3.33 degrees Celsius), circulation of the refrigerant/water mixture around the low side line is able to reduce the temperature of the coolant or refrigerant/water down to approximately 38 degrees Fahrenheit (3.33 degrees Celsius) prior to it exiting the canister. That cool refrigerant and system is capable of cooling air in a secondary system such as an outside building, or is capable of recirculating that cooled antifreeze/water mixture back into the main system to provide greater tonnage to the main system. This provides for a means to obtain additional cool air from a normal air conditioning system by use of the secondary flow of refrigerant through the canister surrounding the low side or high side line.

A second preferred embodiment of the present invention is to provide a source of fluid, preferably anti-freeze and water mixture, through a large canister, of the type disclosed in the first preferred embodiment which encases at least the upper half of an air conditioning system compressor component, wherein the fluid is cool as it enters the canister, and when exits the canister, the fluid has picked up heat from the compressor and in doing so allows the compressor to use less electrical energy and run more efficiently. The fluid is then routed to a radiator or heat exchanger or other such means to cool the fluid before it is returned to the canister.

A third preferred embodiment of the system of the present invention provides that a transformer of the type supplying electrical energy to homes and other buildings is encased in an enlarged canister carrying a fluid, preferably a mixture of antifreeze and water, which cools down the transformer, while the fluid flows through a heat exchanger, such as condenser coils, where the fluid is cooled via air flow from a fan, before the cooled fluid is returned to the fluid coil surrounding transformer to remove heat from the transformer in a continuous closed-circuit system, to enable the transformer to operate more efficiently and to avoid overheating and “blowing” the transformer out of operation.

A fourth preferred embodiment of the system would provide a source of drinking water which is pumped through a first canister surrounding a chilled water line to allow the drinking water to be cooled to a point whereby it could be drunk at a fountain, and the excess water would flow through a drain with a P-trap surrounded by a second canister, and the water in the second canister is cooled and returned to the pump to be re-cycled as cool, unused water back to the fountain.

A fifth preferred embodiment of the present invention is to provide a source of fluid, preferably anti-freeze and water mixture, through multiple canisters on the low and high side lines of an air-conditioning system, of the type disclosed in the first embodiment which encases at least the upper half of an air conditioning system compressor component, wherein the fluid is cool as it enters the multiple canisters, and when exits the canisters, the fluid has picked up heat from the compressor and in doing so allows the compressor to use less electrical energy and run more efficiently. The fluid is then routed to a radiator or heat exchanger or other such means to cool the fluid before it is returned to the multiple canisters.

It is further foreseen that embodiments of the system as described above may include a device whereby a portion of a cool refrigerant line is modified from a straight line to a multiple coiled line, so that the portion of multiple coils in the line may be encased in a canister, whereby the water/antifreeze mixture traveling through the canister, would travel along the wall of the coiled line and in doing so would be cooled down a great deal more than if the fluid in the canister has been cooled by coolant in the straight line.

Therefore, it is a first principal object of the present invention to provide a canister device which is mountable along a first fluid line, such as a Freon®/refrigerant line, or a structure, such as a compressor, of a first air-conditioning system, which is emitting heat or cold from the line or structure, so that a second fluid, such as a mixture of water and anti-freeze traveling through a fluid flow channel in the device, captures the cold or heat from the first line or structure and transfers the heated or cooled fluid to a second destination to provide heat or cold to a second system.

It is a second principal object of the present invention to provide an energy recovery technology canister which is capable of encasing a portion of a line carrying cooled refrigerant from a compressor in order to cool a refrigerant antifreeze-water mixture traveling through the canister so that the refrigerant mixture is reduced in temperature to a point that can be used to cool a secondary system or provide further cool air to the main system.

It is a third principal object of the present invention to provide an energy recovery technology such as a canister surrounding a sealable engaged around a portion of a low side line which can be utilized in residential and commercial buildings and even vehicles such as 18-wheelers or any type of vehicle which uses an air conditioning system therein.

It is a fourth principal object of the present invention to provide a heat transfer system for reducing the temperature of a compressor in an air-conditioning system by circulating a fluid around the wall of the transformer through a large canister, and capturing heat from the compressor, so that the compressor operates more efficiently with less electrical usage.

It is a fifth principal object of the present invention to provide a closed loop heat transfer system to reduce the temperature of a transformer during operation by circulating a fluid through an enlarged canister positioned around the exterior wall of the transformer to extend the life of the transformer.

It is another principal object of the present invention to provide a water cooling system which utilizes multiple canisters in order to cool water going to and returning from a drinking fountain without having to use a separate source of cold water in order to do so.

It is yet another embodiment of the present invention to provide multiple canisters which would be used both in the high side line and the low side line of an air conditioning system, and where a large canister would be utilized around a compressor in order to maintain the water cooled both in the high side and low side line so that the air condition system provides cooler air yet with less amperage than a normal system.

It is yet another embodiment of the present invention to provide a modified canister, which may also be referred to herein as a TopHat™ canister, which would have a double helix of fluid flow channel within the canister body to allow more than one fluid to flow therethrough for cooling or heating a fluid. The modified canister may be constructed of a strong plastic material or out of a metal, such as aluminum.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 illustrates a prior art central air conditioning system;

FIGS. 2A and 2B illustrate schematic view of an air conditioning system within a residential or commercial building, with a secondary building cooled by the present invention;

FIG. 3 illustrates an additional view of the system illustrated in FIG. 1 and further illustrating a secondary system which would be utilizing the cold refrigerant to cool an additional structure;

FIG. 4 illustrates a schematic of the air conditioning system which would be contained in an 18-wheeler, for example, utilizing the present invention;

FIG. 5 illustrates an end view of the canister utilizing the system of the present invention;

FIG. 6 illustrates a side coil section view of a canister utilized in the system of the present invention;

FIG. 7 illustrates a flow diagram of fluid such as refrigerant flowing through the canister utilized in the present invention;

FIGS. 8 and 9 illustrate front and side views respectively of a gasket which would be utilized in two sections of the canister as they are placed together to form the entire canister around the line;

FIG. 10 illustrates an overall view of the embodiment of the present invention relating to cooling of a compressor of an air-conditioning system;

FIG. 11 illustrates the overall view of the system as illustrated in FIG. 10, with the addition of a canister into the system to further cool the cooling fluid;

FIG. 12 illustrates another overall view of the system as illustrated in FIG. 11, further including an auxiliary cooling system to cool a secondary space in addition to the primary space cooled by the system;

FIG. 13 illustrates an exploded view of another embodiment of the system using components to cool a transformer of the type providing electrical power to homes and other buildings;

FIG. 14 illustrates an overall view of the embodiment illustrated in FIG. 13, where the cooling fluid is in place around the transformer to cool down the transformer in its operation;

FIGS. 15 and 16 illustrate views of a closed line water system which allows the water to be cooled from a chilled water outline and flow to a fountain for use and the water from the fountain would cool excess water from the flow line that could be returned into the line and used as cool water;

FIG. 17 illustrates an embodiment of the present invention wherein multiple canisters are used on the high and low side line in order to cool the water in the line so that the air temperature is reduced in an air conditioning system while also cooling the refrigerant from the compressor in the system;

FIG. 18 illustrates a further modified version of the system as illustrated in FIG. 17;

FIGS. 19A-C illustrate views of a refrigerant line which has been modified from a straight line into a coiled line so as to increase the distance that the refrigerant travels within the line that would be placed within a canister so as to cool the fluid entering the canister and reducing its temperature as it exits in the same amount of space as occupied by a straight line;

FIG. 20 illustrates an overall view of the present invention where a modified canister, also referred to as a TopHat™ canister is positioned on the compressor to allow a pair of fluids to travel through the canister body in a double helix pathway for exchanging heat between the fluids to a third fluid;

FIGS. 21 and 22 illustrate a smaller modified double helix canister positioned on the top of the modified canister as an integral part of the modified canister or bolted thereupon;

FIGS. 23 and 24 illustrate the smaller double helix canister having a fluid line therethrough to achieve heat exchange with the fluid line traveling to a single destination or branching into multiple line destinations; and

FIGS. 25 through 28 illustrate an alternate embodiment of the modified canister positioned upon the compressor, including an aluminum sleeve positioned between the modified canister and the compressor to further cool the compressor.

### DETAILED DESCRIPTION OF THE INVENTION

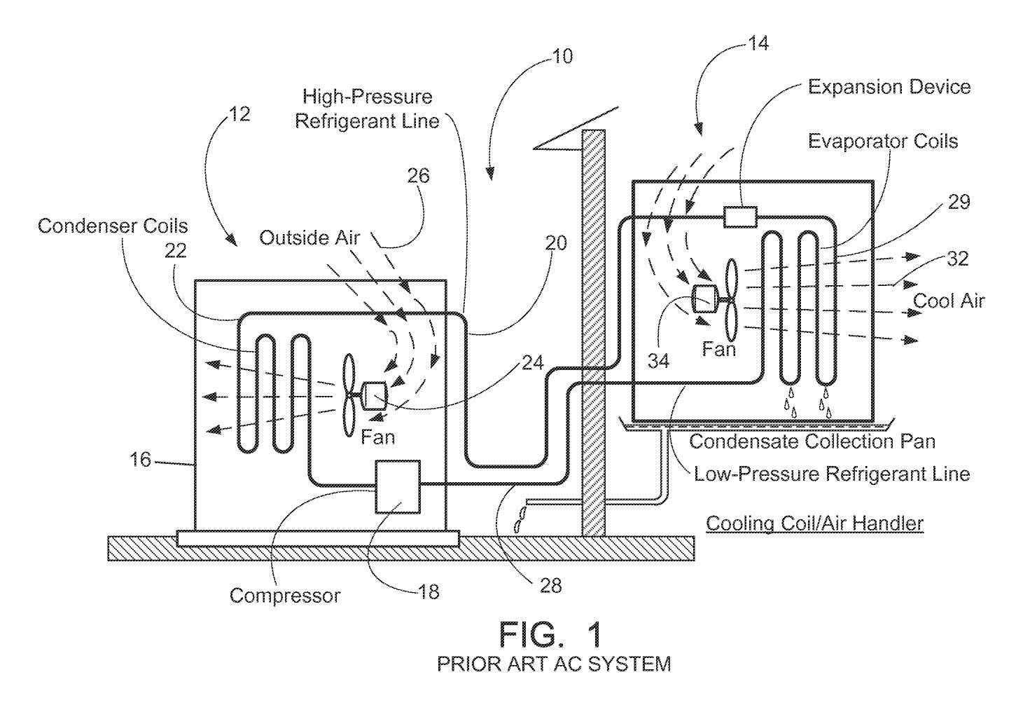

FIG. 1 illustrates a typical prior art home/building air conditioning system.

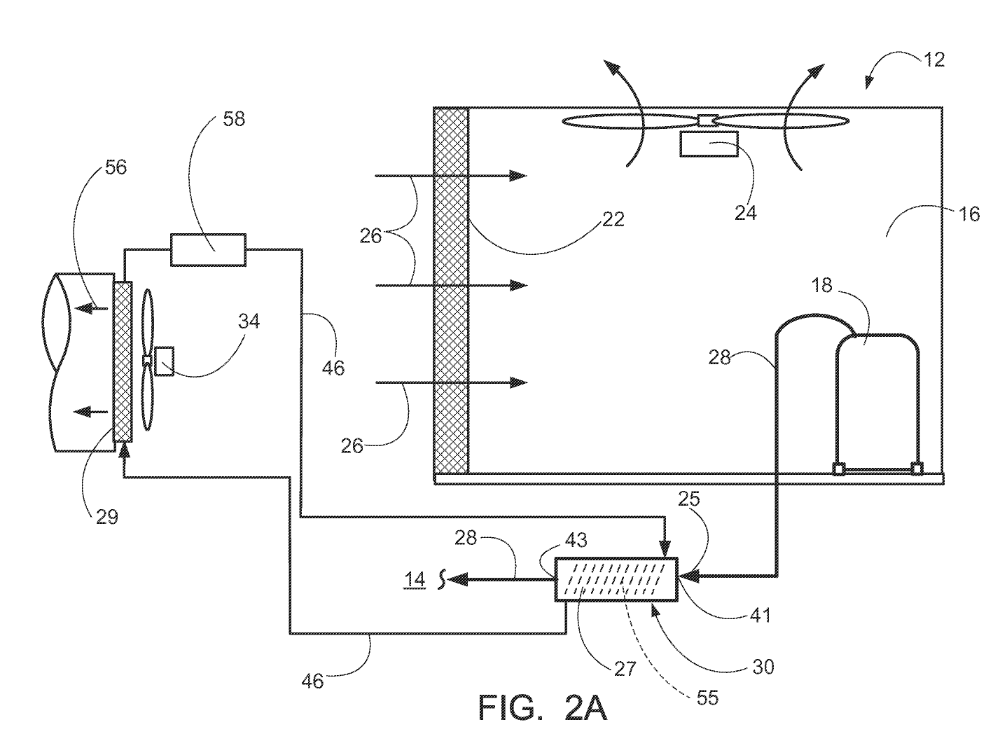

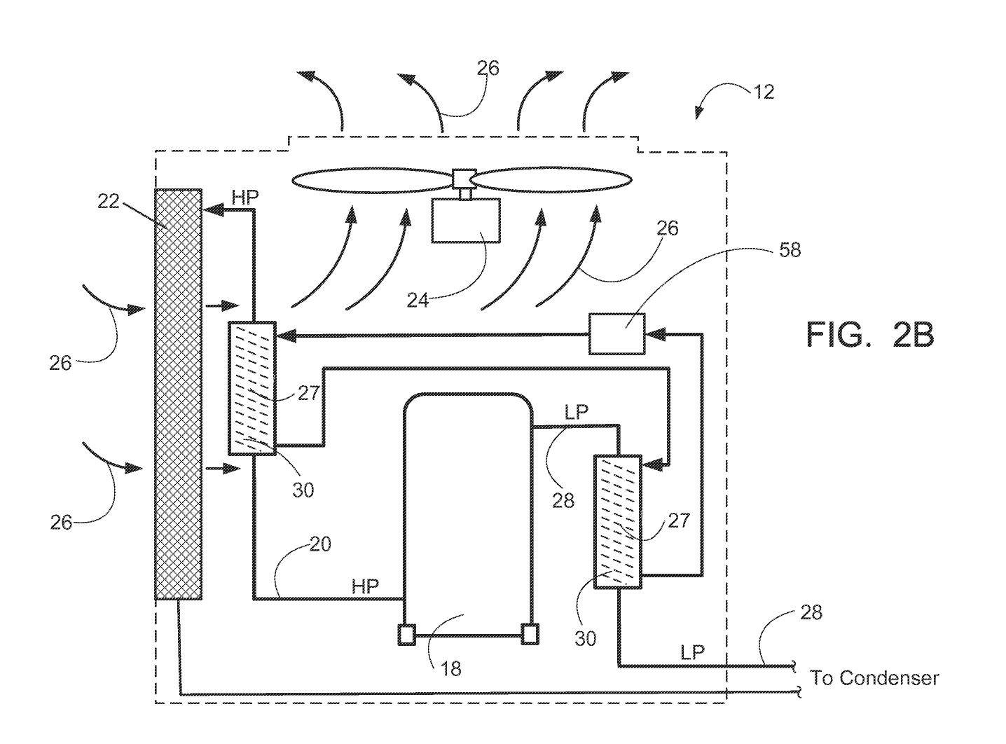

FIGS. 2A-9 illustrate a first preferred embodiment of the system of the present invention wherein an energy recovery technology canister which is capable of encasing a portion of a line carrying cooled refrigerant from a compressor in order to cool a refrigerant antifreeze-water mixture traveling through the canister so that the refrigerant mixture is reduced in temperature to a point that can be used to heat a secondary system or provide further cool air to the main system.

Before a discussion of the present invention, reference is made to FIG. 1 which illustrates how a typical, prior art, Air Conditioning (AC) system for a building, such as a home, works. There is illustrated the entire primary AC system 10 having an exterior section 12 and interior section 14, which may be utilized within a home. The exterior section 12 comprises an open enclosure 16 housing a compressor 18, with a high side or high pressure line 20 carrying a refrigerant 25, such as Freon®, from the home for re-cooling. The refrigerant 25 travels through a series of condenser coils 22. There is included a fan 24 which draws outside air, depicted by arrows 26, which flows through the coils 22 to cool down the refrigerant 25 before it enters the compressor 18. The cooled refrigerant 25 exits the compressor 18 through a low pressure or low side line 28 at a low temperature, such as, for example, 38 degrees F. (3.3 degrees Celsius), and travels into the interior section 14. The cooled refrigerant enters a series of evaporator coils 29, where air, depicted by arrows 32, within the home is pulled via a fan 34 through the coils 29, cooling the air as it is blown throughout the home. This air is re-circulated through the evaporator coils 29 by fan 34 in a continuing cycle as the refrigerant 25 is re-cooled by the compressor 18 in the exterior section and returned to the interior section for cooling the air in the home.

Before a discussion of the invention, it should be understood that the prior art air conditioning system described in FIG. 1 typically utilizes Freon® or a refrigerant as the coolant. However, the present invention, as will be described in FIGS. 2A through 9 utilizes a refrigerant mixture, which preferably would be a mixture of water and antifreeze. The fluid mixture for flowing through the canister may also comprise mineral oil, cotton seed oil, and grape oil. The mineral oil, cotton seed oil or grape oil may be used in combination with water and/or antifreeze, or may be utilized alone for flowing through the canister. It is foreseeable that the fluid mixture may be biodegradable and that any fluid mixture that will achieve the energy transfer as discussed herein for picking up heat or cold emanating from the refrigerant line or other device may be used with the present invention. As indicated, an antifreeze and water mixture is the preferred fluid mixture.

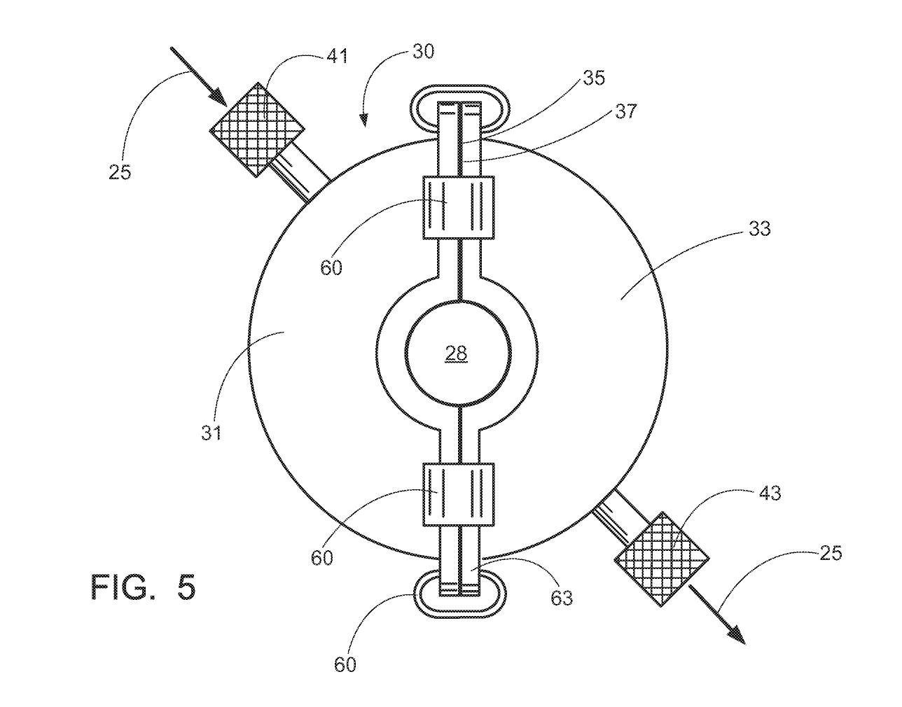

Turning now to a first embodiment of the system utilizing the present invention, as illustrated in FIG. 2A through 9, FIG. 2A illustrates the most efficient operation of the first embodiment of the present invention. In this embodiment, there is illustrated an exterior section 12, similar to the exterior section as described in FIG. 1, where there is the enclosure 16 housing the compressor 18, the low side low pressure line 28 which carries the cooled refrigerant 25 from the compressor 18 through line 28 to the interior section 14, to the evaporator coils 29. The positioning of a canister 30 will be described in detail in reference to FIGS. 5 through 9. The canister 30 is positioned to encase a portion of line 28, and has a continuous flow channel 55 throughout the canister 30 which allows the antifreeze/water mixture 27 (also referred to as refrigerant mixture 27), from a second source to enter the canister 30 through intake port 41, travel through the channel 55 in a circular fashion around line 28, and exit from the canister 30 at outflow port 43, having been cooled by the refrigerant in line 28 to a temperature equal to or close to the temperature of the refrigerant in line 28. The refrigerant mixture 27 exiting canister 30 flows through a separate cooled refrigerant line 46 through evaporator coils 29 positioned in a second structure, such as a garage, and a fan 34, blows air, depicted by arrows 56, through the coils 29 to cool the air entering the second structure. The refrigerant mixture 27 is returned to the canister 30 via line 46, driven by pump 58, in a continuous closed loop system. So in effect, what is being shown is a system where it has a principal cooling means for cooling the principal building, with the use of one or more canisters 30 surrounding line 28, allows cold refrigerant mixture 27 to then flow into a secondary system. The air cooled by the cool refrigerant mixture 27 in the canister 30 is able to cool a secondary building which in effect translates into greater tonnage. So the resulting effect is that a 3 ton unit, for example, which would be normally used to cool a home, could also have an additional one to three tons of cool air that go into a secondary structure.

Turning now to more involved embodiments of the first embodiment of the system, reference is made to FIGS. 2B through 4. FIG. 2B, illustrates a view of the exterior portion of a home, building or commercial air conditioning system where there is provided a compressor 18, high pressure in flow line 20 leading into the compressor 18, a system of insulated condenser coils 22 through which air flows into the system pulled in by fan 24 in the direction of arrows 26, as described in relation to FIG. 1. As part of the present invention, there is further illustrated a canister 30 at a first position and a canister 30 at a second position as will be described further. Further illustrated is a motor or pump 58 for moving the air through the canisters 30. In describing what is occurring in FIG. 2B, air which would be utilized from the outside is pulled in through the coils 22 via the fan 24. This air travels through the coils 22 and in doing so cools the refrigerant fluid within the coils 22 prior to the fluid being returned to the compressor 18. When the cooled refrigerant, or Freon®, leaves the compressor 18 via the low line 28 under low pressure, the cooled refrigerant is routed through line 28 which is being encased by the canister 30 of the type that will be described further. A volume of antifreeze/water refrigerant 27 is pumped through the continuous flow channel 55 within the canister 30 and in doing so, the refrigerant mixture 27 is cooled by the cold refrigerant 25 within line 28 down to the temperature of the refrigerant 25, which may be approximately 38 degrees Fahrenheit (3.3 degrees Celsius). This cooled refrigerant mixture 27 is then circulated via motor 58 into the coils 22 which would allow further cooling so that when the refrigerant 25 is returned into compressor 18, it is generally cooler.

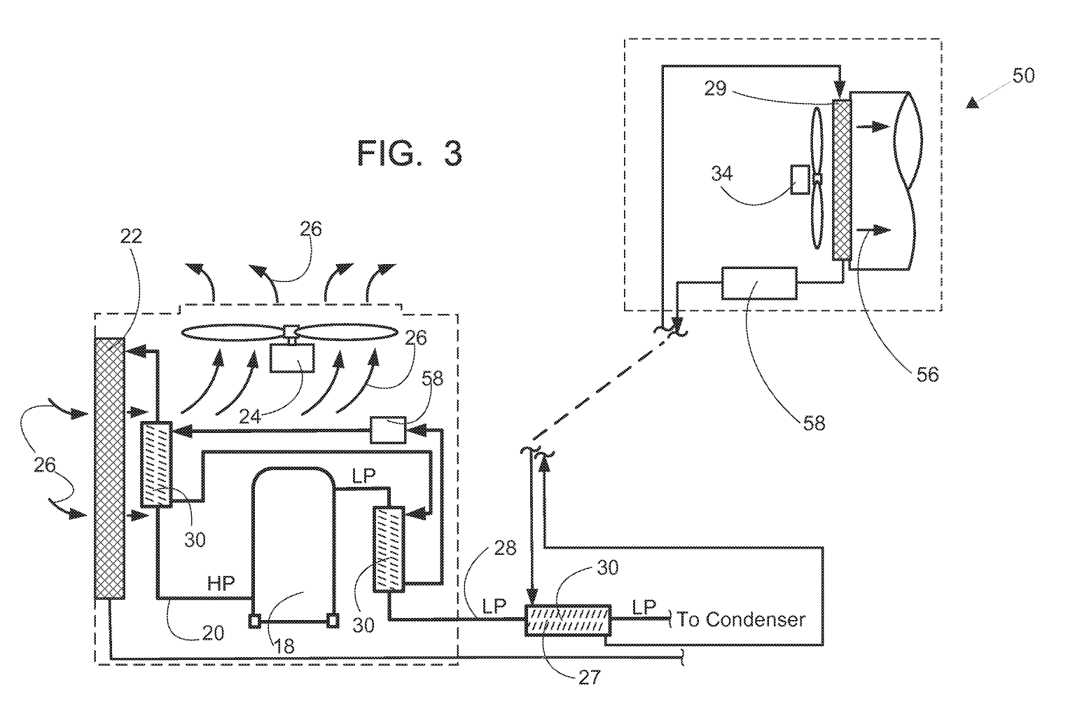

Turning now to FIG. 3, there is illustrated the first embodiment of the system 10 as was described in FIG. 2B. However, as noted in low pressure line 28, the cooled refrigerant is leaving the compressor 18 and travels through canister 30. Canister 30, as will be described further in FIGS. 5 through 9, contains a circular flow of refrigerant mixture 27 therethrough and is cooled down to about 38 degrees Fahrenheit (3.3 degrees Celsius) so that when the cooled refrigerant mixture 27 exits canister 30 via outflow port 43, it travels through a second canister 30 for further cooling and then into a secondary system 50 wherein the cool refrigerant mixture 27 enters into a second set of coils and the air blown via fan 34 through the coil 29 in the direction of air 56 would be cooled and routed to an auxiliary building 70 (not shown) for cooling the building. Such a building could be a garage, carport or other area. While that is occurring, the principal flow line of air to the condenser is traveling to the main building 82 (not shown), such as a home or commercial building, and cools that also. So in effect, what is being shown is a system where it has a principal cooling means for cooling the principal building, and with the use of multiple canisters 30 allows cold air to then flow into a secondary system. This cold air cooled by the cool refrigerant mixture 27 in the canister 30 is able at the same time to cool a secondary building which in effect translates into greater tonnage, so in effect a 3 ton unit which would be normally used to cool a home could also have an additional one to three tons of cool air that go into a secondary structure. The system would also work to provide additional tons of cool air with units of other tonnage capacity.

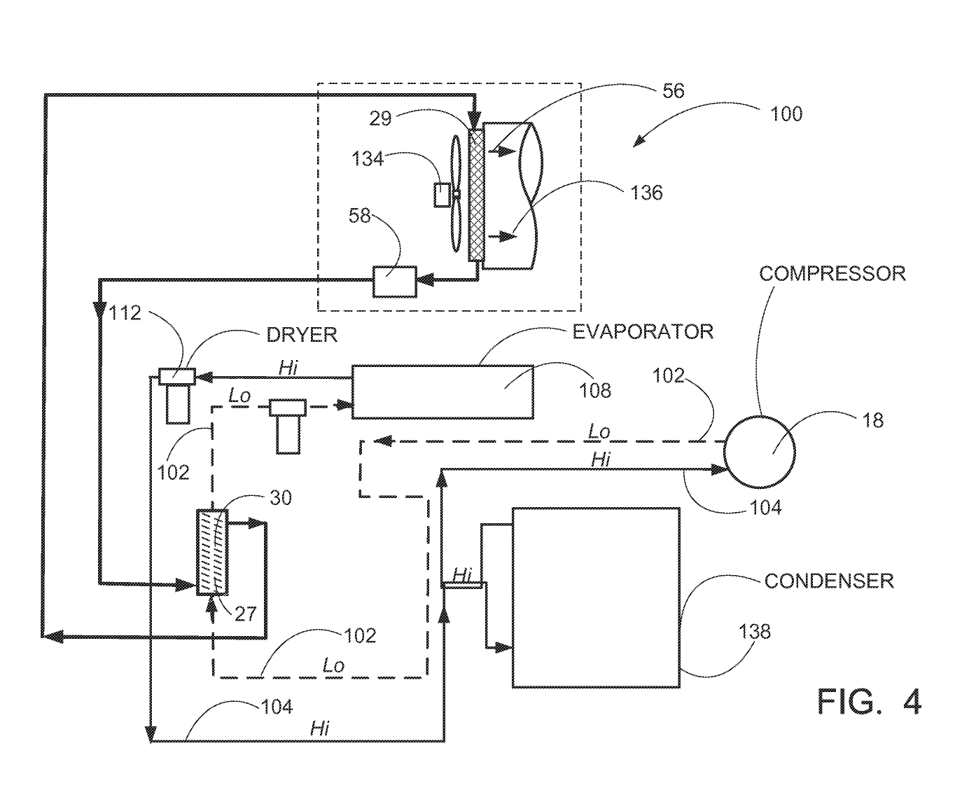

Turning now to FIG. 4, there is further illustrated the first embodiment of the system, schematics of an 18-wheeler by the numeral 100 (not shown). There is a compressor 18 with the low side line 102 and a high side line 104. The compressor 18 would send cold air via line 102 to an evaporator 108 and from the evaporator would travel through a high side line 104 to a dryer 112 and then would travel through a canister 30. The refrigerant 27 cooled by the canister 30 would travel to a fan or to the blower 134 and the fan would blow the cool air, depicted by arrows 136, into the cab for keeping the cab cool. As further illustrated, the condenser 138 is standardly used in an 18-wheeler.

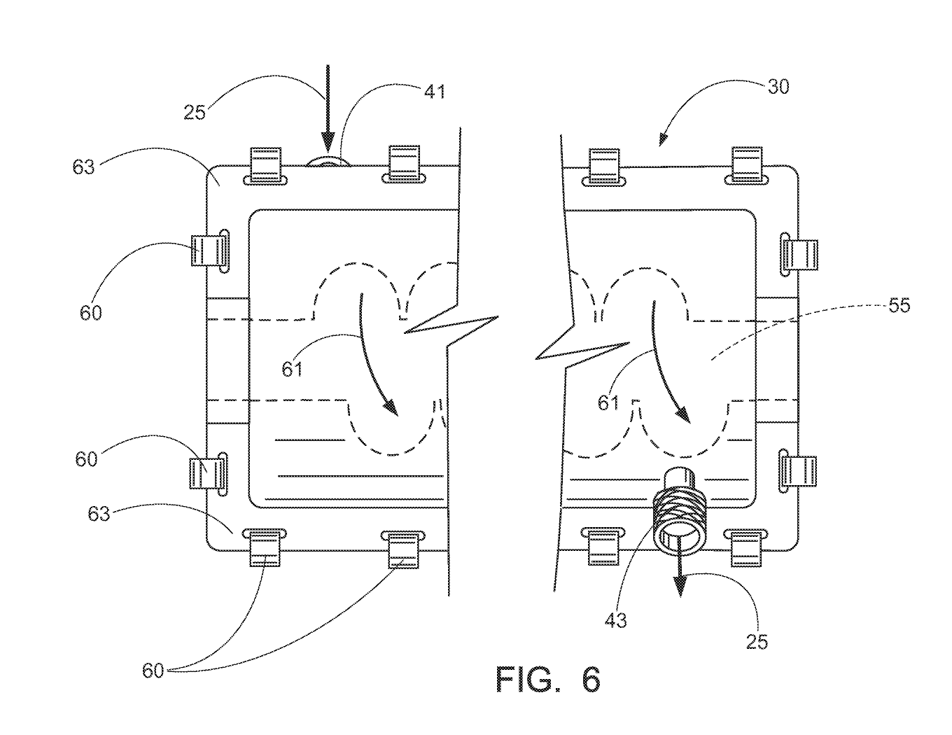

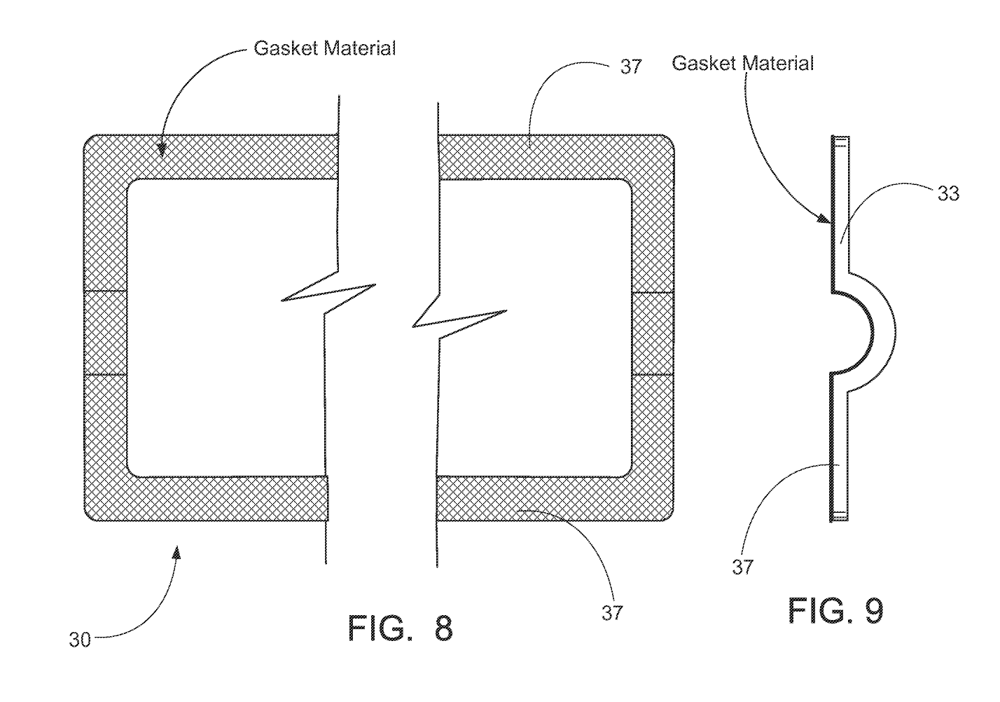

Turning now to the construction of the canister itself utilized in the first embodiment of the system, reference is now made to FIGS. 5-9. As illustrated first in FIG. 5 there is illustrated an end view of the canister 30, having the first half body portion 31 and the second half 33 joined together or on a common surface 35 wherein there is a gasket 37 formed there between. That gasket is clearly shown in FIGS. 8 and 9. Further, the elongated canister would preferably be from one to two (1 to 2) feet (0.3 to 0.6 meters) long would have a first intake port 41 and a second outflow port 43. The intake port 41 would allow a mixture of refrigerant antifreeze/water mixture 27 to enter into the canister and eventually flow through the outflow port 43. The refrigerant mixture 27 is flowing through the canister into port 41 and flows into a flow channel 55 within the canister 30. The canister is preferably constructed of a hard plastic material 53 wherein there is formed within the plastic continuous flow channel 55 which allows the refrigerant mixture 27 as it enters into the cavity of the canister to flow through the canister in a circular direction as seen in FIG. 6 by arrows 61. So as for example, as shown in FIG. 6, as the refrigerant mixture 27 travels through the canister body 30, it is circulating many times around the cool refrigerant line 28 as was described earlier so that when the refrigerant mixture 27 in the canister 30, depicted by arrows 61, finally exits the outflow line 43 of the canister, it has traveled through many revolutions around the cold cooper line 28, and in doing so, is sufficiently cool so that when it exits port 43 it exits at a substantially cooler temperature. For example, the refrigerant mixture 27 may enter intake port 41 at 90 degrees Fahrenheit (32.22 degrees Celsius) and because of it traveling in that circuitous motion through the cavity of canister 30, it has cooled itself down to 38 degrees Fahrenheit (3.3 degrees Celsius) in the preferred embodiment.

FIGS. 8 and 9 are simply views of the gasket 37 which was described earlier which is a typical gasket and would form a seal between the two half body portions 31 and 33 of the canister 30. In FIG. 8 there is a side view showing for example, half body 31 and the canister where the gasket material completely lines so that no fluid at all can exit the canister while it is held in place. As an aside, turning back to FIG. 5, it is noted that the canister has a plurality of sealing members 60 which surround the entire outer body of the canister so that it is completely sealed along its entire border 63, thus preventing the refrigerant mixture 27 circulating through the canister from leaking out, as illustrated in FIG. 5.

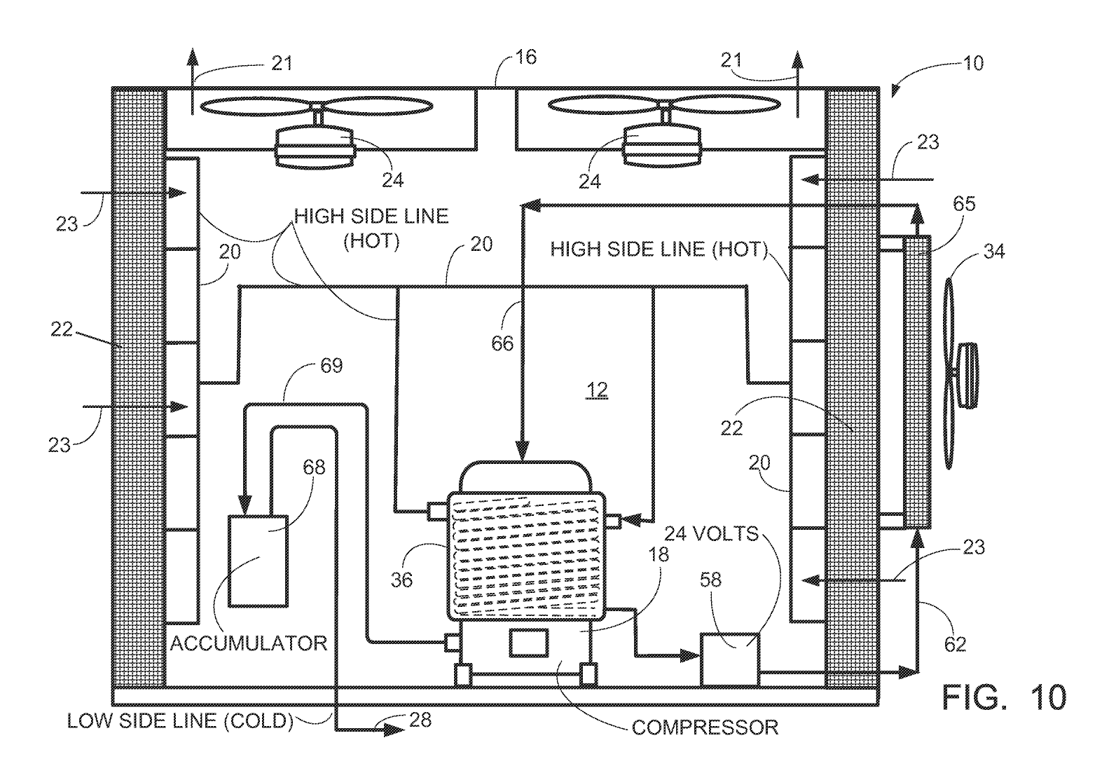

Turning now to the second embodiment of the system, reference is made to FIGS. 10 through 12. This embodiment is designed to cool down a compressor 18 in a central air conditioning system, so that the compressor 18 operates more efficiently and uses less energy, as will be seen below.

FIGS. 10-12 illustrate overall views of a second preferred embodiment of the system of the present invention wherein a compressor component of an air conditioning system is cooled by the flow of fluid, preferably antifreeze and water mixture, around at least the upper half portion of the compressor to cool the compressor, and the fluid flowing through a radiator to a dryer and accumulator to further cool the fluid so that the compressor utilizes less electrical energy and provides greater cooling to the Freon in the compressor.

As illustrated in FIG. 10, there is provided a central air conditioning system, with the exterior portion 12 of the system, which would normally be positioned exterior to the structure being cooled or heated. As seen in FIG. 10, there is provided an open enclosure 16 having a main compressor component 18, with first and second cooling coils 22 on both sides of the exterior portion 12. Air would be drawn through the coils 22, in the direction of arrows 23 by the pair of fans 24, to help cool the fluid flowing through coils 22, and flow out of the enclosure 16 as seen by arrows 21. There is illustrated an enlarged canister 36, which would be constructed similarly to the canister 30 as disclosed in the first embodiment, where enlarged canister 36 would be positioned at least at the upper half of the compressor 18, through a series of coils as illustrated. The enlarged canister 36 would have a continuous channel formed in the body of enlarged canister 36 to allow the flow of a refrigerant mixture 27, preferably an antifreeze/water mixture, to flow therethrough. The flow of the refrigerant mixture 27 is within a closed circuit. The refrigerant mixture 27 would flow via a pump 58, which would pump the fluid out of the enclosure 16 into a radiator 65 via line 62, so that air flowing into the enclosure via fans 24 would cool the refrigerant mixture 27. The fluid would then return to the enclosure via line 66, having been cooled by the radiator 65, and would return into enlarged canister 36 flowing around the compressor 18. In doing so, the refrigerant mixture 27 in the enlarged canister 36 would pick up heat from the compressor 18, thereby cooling down the compressor 18, and the result is that the compressor 18 operates by using less energy, and cools more efficiently. The cool air exiting the compressor 18 would flow from the compressor via line 69 into an accumulator 68, before the cooled air enters the low side/low pressure line 28, and travels to the interior system 14, to cool the structure.

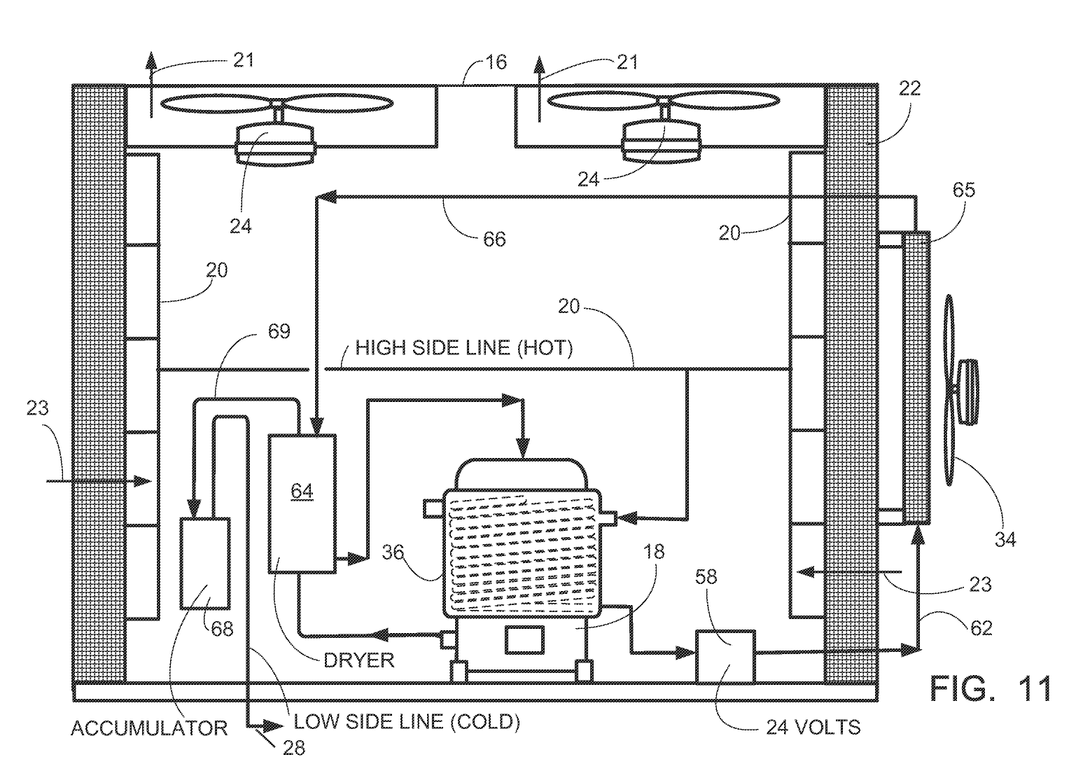

In FIG. 11, there is illustrated the same system as discussed in regard to FIG. 10, except that there is provided a dryer 64 which would receive the cooled refrigerant mixture 27 from line 66, prior to the fluid flowing into the enlarged canister 36 surrounding the compressor 18. The dryer 64 would cool the refrigerant mixture 27 entering the enlarged canister 36, while at the same time, the dryer 64 would receive the cool air flowing from the compressor through low side/low pressure line 69 carrying the air to the dryer 64, then to the accumulator 68, prior to the cool air flowing into that portion of line 28 carrying the cool air into the structure.

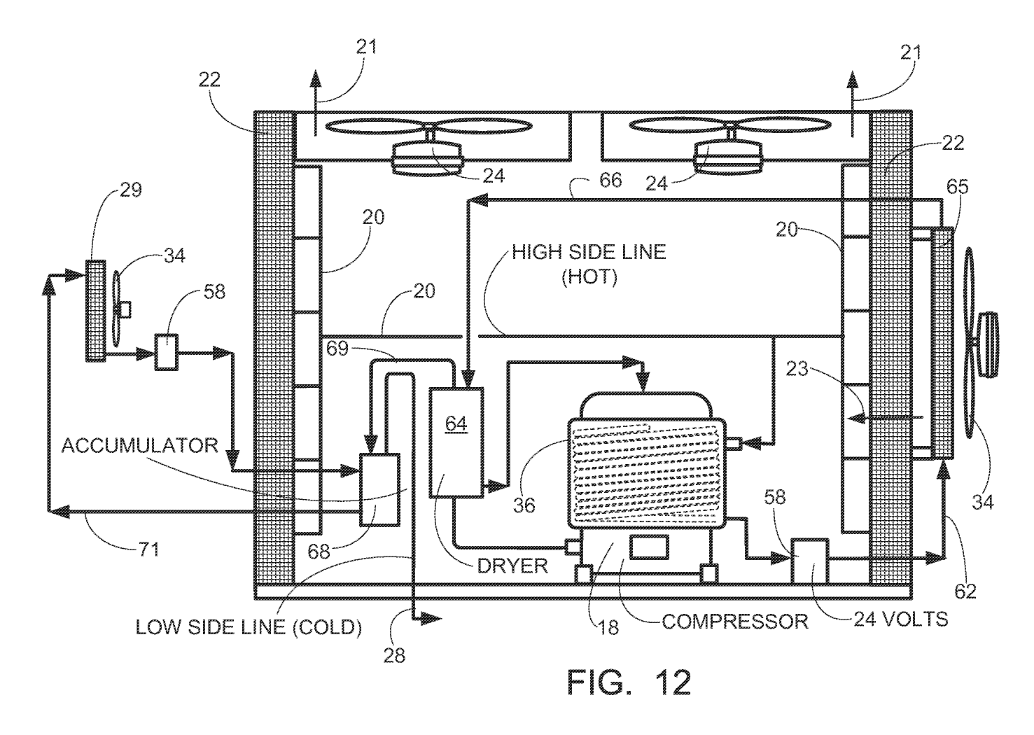

In FIG. 12, the system is modified from the system illustrated in FIG. 11. In FIG. 12, after the cool air enters the accumulator 68, a portion of the cool air is channeled via a line 71 into a secondary cooling system where there is provided a pump 58 to pump the air through evaporator coils 29, for example in an auxiliary building, and a fan 34 would blow air through the coils 29 to provide cool air into the auxiliary building. The cool air would then be returned to the accumulator 68, while the other cooled air in the accumulator 68 would travel to the main interior section 14 to cool the main structure. So, in this modification in addition to the compressor 18 being cooled down, excess cooled air is channeled to an auxiliary system to cool an auxiliary building, such as a shed or garage, for example.

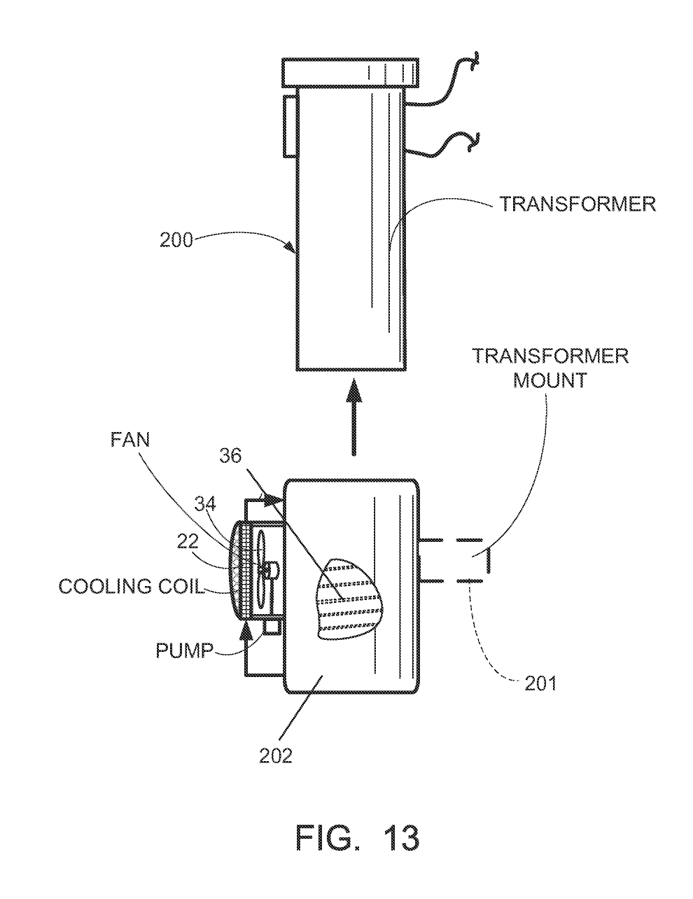

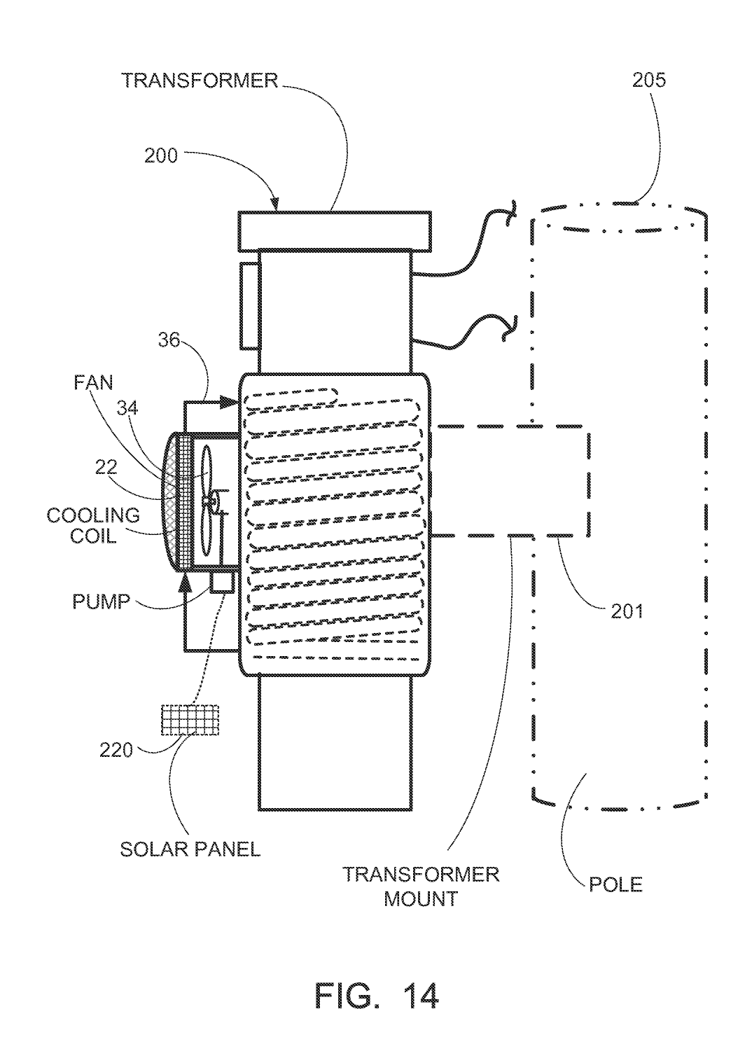

FIGS. 13-14 illustrate a third preferred embodiment of the system of the present invention wherein a transformer 200 of the type supplying electrical energy to homes and other buildings is mounted on a pole 205 or the like via a transformer mount 201. The transformer 200 is encased in an enlarged canister 36 carrying a refrigerant mixture 27, preferably a mixture of antifreeze and water. The refrigerant mixture 27 would cool down the transformer 200. The refrigerant mixture 27 would then flow through a heat exchanger, such as condenser coils 22, of the type shown in FIG. 12, where the refrigerant mixture 27 is cooled via air flow from fan 34, before the cooled refrigerant mixture 27 is returned to the fluid enlarged canister 36 surrounding transformer 200 to remove heat from the transformer 200 in a continuous closed-circuit system. It is foreseen that the pump 58 and fan 34, among other components if necessary, could be powered by electricity from a solar panel 220 mounted on the pole 205, also. This would enable the transformer 200 to operate more efficiently and to avoid overheating and “blowing” the transformer out of operation. Also, in an embodiment as shown in FIG. 13, there is illustrated an enclosure 202 surrounding the enlarged canister 36 around transformer 200, so that the condenser coil 22 and fan 34 assembly can be mounted thereon and operate as a closed system. It is foreseen that such a system could be positioned around all transformers 200 currently in use, so that the life of the transformers 200 is extended by maintaining the transformers 200 in a cooler state during operation. It is also foreseen that in some cases there could be no enclosure 202 around enlarged canister 36, in which case the condenser coil 22 and fan 34 assembly would be mounted directly to the outer wall of enlarged canister 36.

It is foreseen that the embodiments of the system discussed herein in relation to FIGS. 12-14 could be adapted to any elements of a system where heat loss could be captured in the manner discussed and used to provide further energy. For example, in some industrial applications, large tanks are utilized for various purposes, wherein the tanks are overheated in their use. If the enlarged canister 36 could be positioned around at least a portion of these tanks, and the refrigerant mixture 27 flow through the canister 36, the refrigerant mixture 27 would pick up heat from the exterior of the tanks, and the fluid could flow to a second location to provide heat to serve as energy to that location. Therefore, one would be capturing heat that would normally be lost, into the refrigerant mixture 27, where the heated refrigerant mixture 27 could be transported and used to provide energy, in the form of heat, to another location. If, however, one just wanted to bring the temperature of the tanks down, the refrigerant mixture 27 could flow as it flows in the embodiment to cool transformers 200, as discussed in relation to FIGS. 13 and 14, and the tanks would be maintained at a lower temperature as desired.

It should be made clear that although the present invention as described herein is utilized as a means for providing additional cool air in an air-conditioning system, it is foreseen that the heat exchange system described herein in the three embodiments may be utilized in a heating system, where fluid passed through the canister 30 or enlarged canister 36 may be heated by hot fluid flowing through the principal line and increase the heating capacity of a heating system, such as a heat pump or the like system. The same principle of heat/cold transfer between the fluid in the principal low side line and the fluid within the canister 30 or enlarged canister 36 is the same.

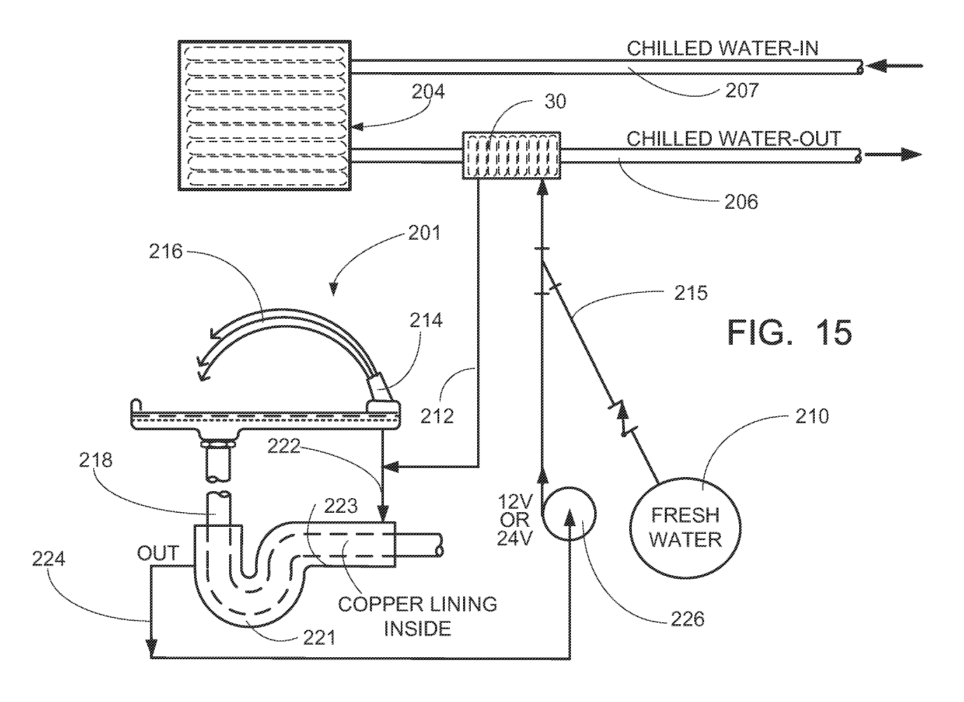

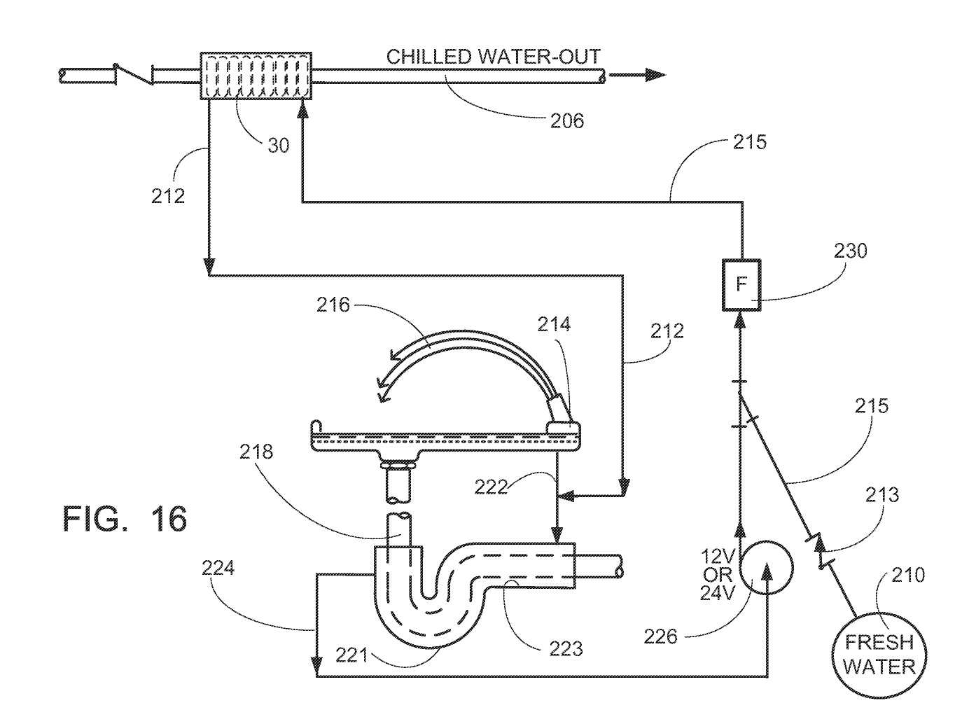

In FIGS. 15 and 16 there is illustrated yet another embodiment of the present invention as illustrated. There is an air conditioning system 204 which has a chilled water inline 207 and a chilled water outline 206. There is a canister 30 of the type utilized in the first and second embodiments which would be placed around the chilled water outline 206 and a source of fresh water 210 would be pumped into flow line 215 so that when it exits the canister 30, the fresh water is cooled by the chilled water outline 206. The water would then flow through line 212 and enter into a fountain 214 where it would be utilized as drinking water by arrows 216. The cooled water which would not be drank would flow through a typical P-trap drain 218, and since the water 216 would still be cooled, the P-Trap 218 is encased by another modified canister 221, which would be fed by a clean water flow line 222. The canister 221 would have a copper lining 223 inside as to assure there are no leaks, and the water 216 within the canister 221 remains in the clean water flow line 222. The cool water in the drain line 218 would cool the water in the canister 221 and the water would flow from the canister 221 to an outline 224 and into a pump 226, where it would be pumped back into the flow line 212 and into fountain 214 and would be recycled. In this embodiment, the source of water for the fountain water is being cooled by the flow through canister 31 around chilled outline 206, and therefore there is no requirement for separate source of cooled water other than the canister 31 which is placed around the chill water outline 216 and around the canister 221 surrounding the P-Trap drain 218. It should be noted that flow line 215 includes a regulating valve 213 to regulate the flow from the clean water source 210 as the water joins the water flow from the water line 224. Also, as seen in FIG. 16, there could be included a water filter 230 in line 215 before the water returns to the canister 30 to be re-cooled.

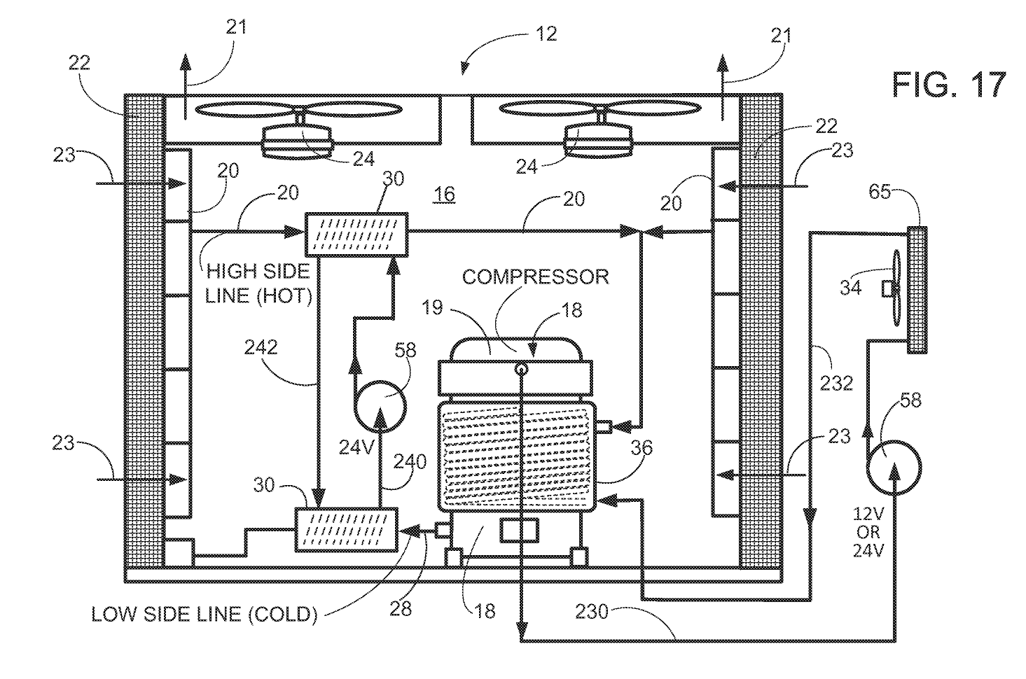

As illustrated in FIG. 17, there is provided a central air conditioning system, with the exterior portion 12 of the system, which would normally be positioned exterior to the structure being cooled or heated. As seen in FIG. 17, there is provided an open enclosure 16 having a main compressor component 18, with first and second cooling coils 22 on both sides of the exterior portion 12. Air would be drawn through the coils 22, in the direction of arrows 23 by the pair of fans 24, to help cool the fluid flowing through coils 22, and flow out of the enclosure 16 as seen by arrows 21. There is illustrated an enlarged canister 36, which would be constructed similarly to the canister 30 as disclosed in the first embodiment, where enlarged canister 36 would be positioned at least at the upper half of the compressor 18, through a continuous coiled bore in the body of the canister 36 as illustrated. In this embodiment, the top 19 of the compressor 18 would have a line 230 which would supply cooled refrigerant mixture 27 to a pump 58 which would pump the refrigerant mixture 27 through the radiator 65 in the structure to be cooled by fan 34. The refrigerant mixture 27 exiting the radiator 65 through line 232 would be fed back into the compressor 18 to be re-cooled.

While this typical process is occurring, a second low side line 28 would be encased in a first canister 30. The canister 30 would have the water/antifreeze mixture 27 that would be cooled by the Freon® or refrigerant in the low sideline 28. The water in the canister 30 would be pumped through a line 240 via pump 58 and travel through a second canister 30 encasing a portion of the high side line 20 to cool the Freon traveling through high side line 20, and would return to the first canister 30 on low side line 28 via line 242. As illustrated the water/antifreeze mixture would be traveling in a closed loop system between the low side line 28 and the high side line 20. It is also noted that the high side line 20 which exits the condenser coils 22 has a portion 20 which sends the Freon® to be cooled into the compressor 18.

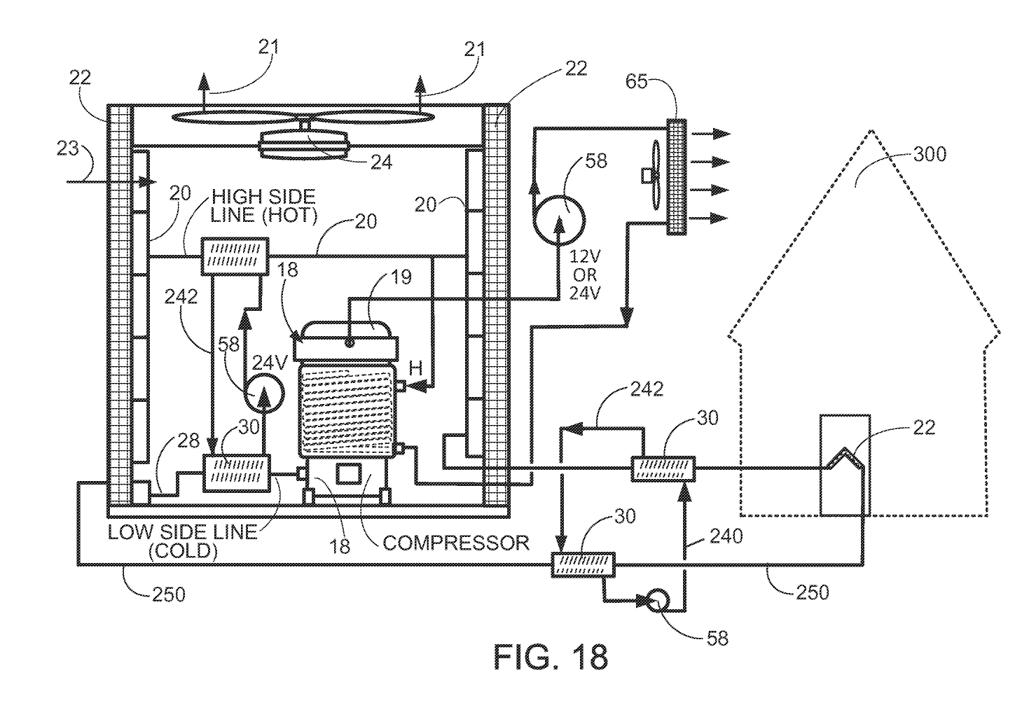

In FIG. 18, this is a similar system as described earlier in regard to FIG. 17 except for the fact that the low side line 28 is carrying the cool Freon to an air-conditioning system in a building 300. In this Figure, the cooled Freon travels through a line 250 to the AC unit in the building. A portion of the line 250 is encased in a first canister 30 having the water/antifreeze mixture 27 which is cooled, and a pump 58 pumps the cooled mixture 27 to a second canister 30, via line 240, encasing a portion of the high side line 20, to cool the fluid returning from the building 300. The fluid mixture travels from the canister 30 on the high side line to the canister 30 on the low side line 28 to be re-cooled. This closed loop canister system allows further cooling the fluid within the lines to reduce the amount of energy required to maintain the AC system in operation.

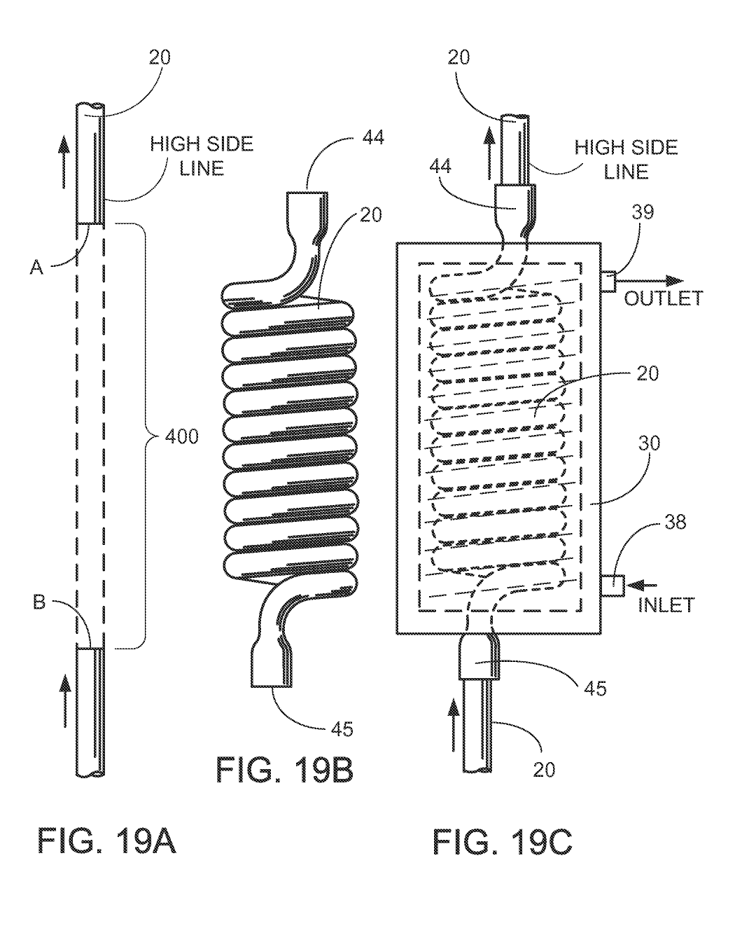

Turning to FIGS. 19A-C, FIG. 19A illustrates a removed section 400 of straight Freon highside line 20 which section 400 would be approximately 18″ (inch) (45.72 cm) in length from point A to point B. Next, one were to remove the 18 inch (45.72 cm) section of line 20, and then coil the line 20, as seen in FIG. 19B, to define coiled line 20, having ends 44 and 45. The coiled line 20 would then be spliced at ends 44, 45 into the area of line 20 which is shown in phantom view FIG. 19A. The coiled line 20 would occupy that same space as the straight line 20 in FIG. 19A, but have a much longer distance to travel through the coiled line 20 rather than the 18″ occupied by straight line 20 in FIG. 19A. Then one would place a canister 30 of the type utilized in the system where cool water/antifreeze mixture would flow into inlet 38 through the canister 30, and instead of making contact with only this 18″ (inch) (45.72 cm) portion of straight line 20, it would make contact with multiple surface areas of the coiled line 20. Therefore, when the water exits the outlet 39 in canister 30, it is cooled down a significant amount rather than if it were only in a straight line 20. This kind of modified line can be used in any system that would require a freon line and where you would have enough space in order to coil it so that a canister 30 could be placed around it.

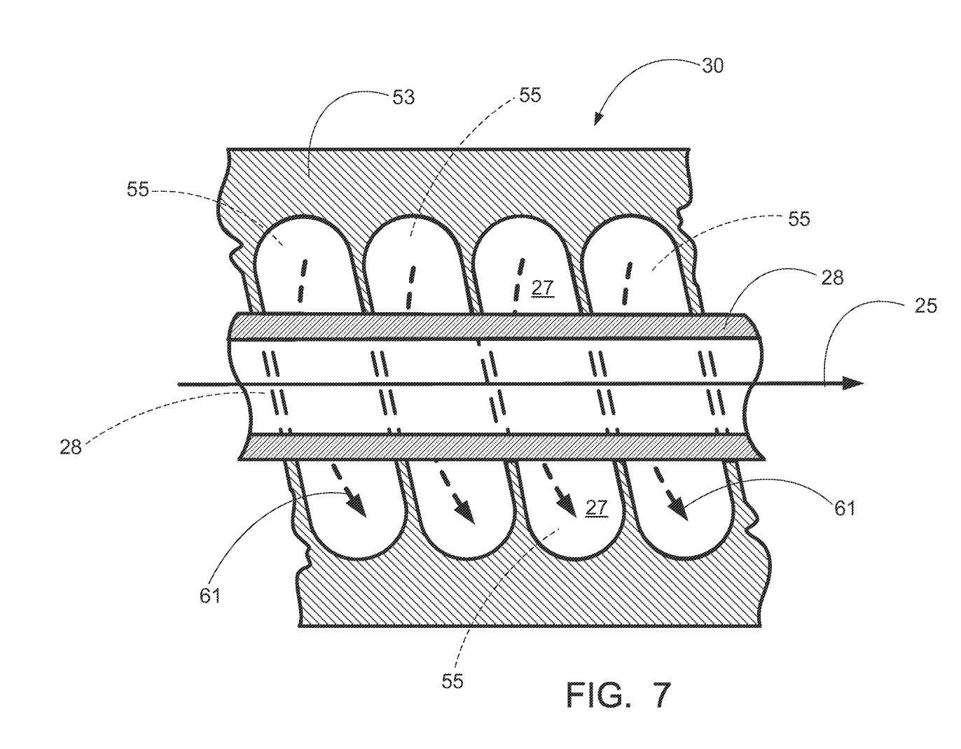

Although FIGS. 19A through 19C discuss the use of a coiled line 20 enclosed within a canister 30, it is foreseen that the canister 30 could be provided with a continuous coiled passageway, of the type as discussed in FIGS. 6 and 7, through the canister body, through which the mixture would flow, which would eliminate the need for a coiled flow line 20.

Finally, throughout the discussion of the various embodiments of the present invention, the canister 30 or enlarged canister 36 are preferably molded from a plastic material, it should be understood that canister 30 or 36 could be constructed of any equivalent material which could be molded or fabricated to function in the manner disclosed herein, which would be currently available or invented in the future.

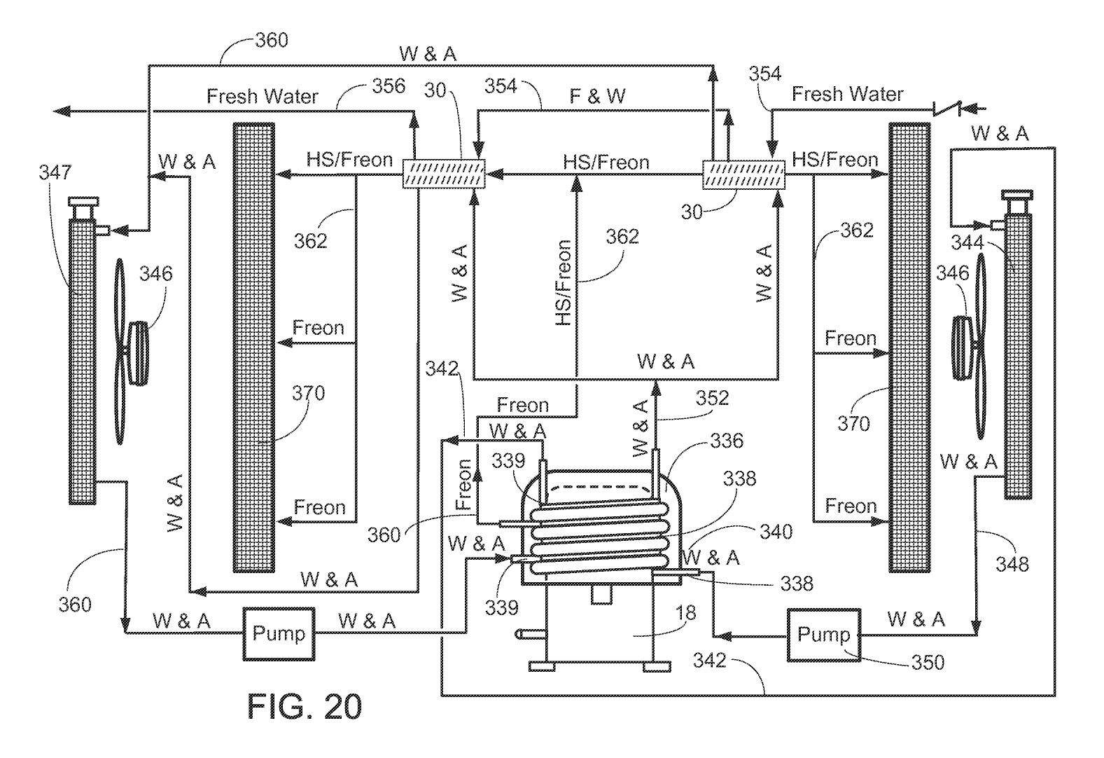

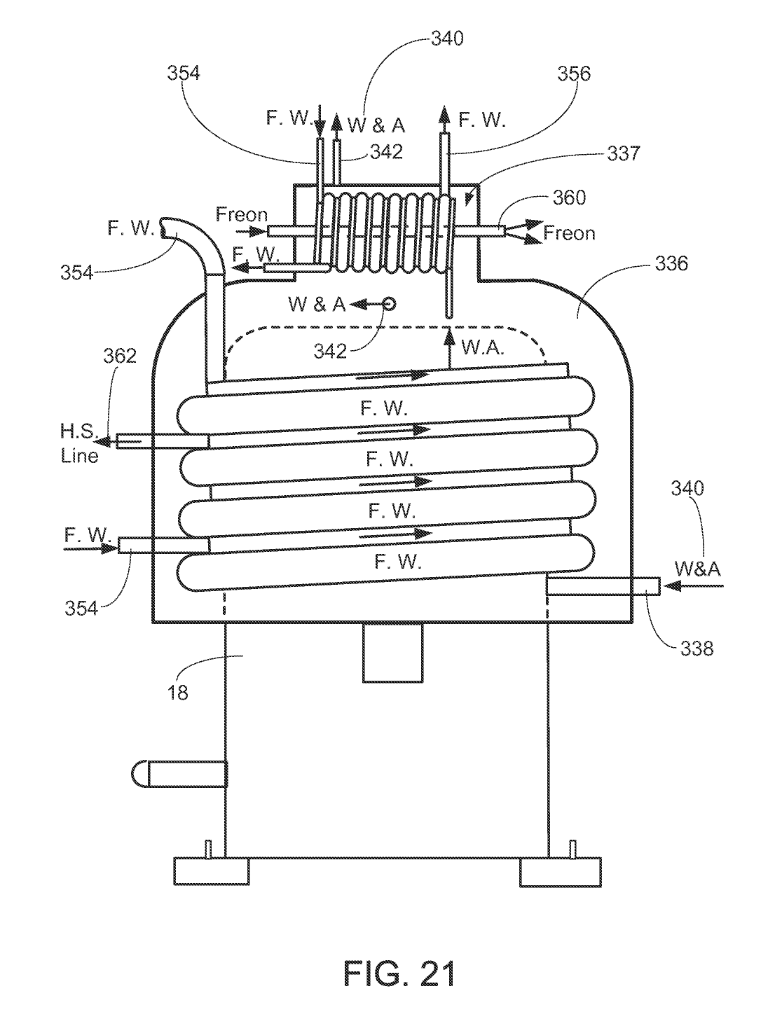

Reference is now made to FIGS. 20 and 21 which illustrate another embodiment of the system of the present invention which utilizes a modified enlarged canister 336, which will also be referred to as a TopHat™ canister 336, which would be positioned on the upper portion of a typical compressor 18 of an air-conditioning system 12 as illustrated in FIG. 20. In this embodiment, the canister 336 has been modified to include a double helix of fluid channels 338, 339 with each fluid channel 338, 339 delivering a mixture of water and antifreeze (W&A) 340 through the double helix channels 338, 339 so that the mixture 340 picks up heat from the upper end of the compressor 18 and delivers it to a first exit channel 342, where it is routed to a first radiator 344, and the mixture 340 is cooled by a fan 346. The mixture 340 is then returned from radiator 344 into a return line 348, and pumped via pump 350 back into the channel 338 into the canister 336, to undergo another circuit as described. While this is happening, the W&A mixture 340 exits the canister 336 through a second exit channel 352 where the channel 352 splits and delivers the mixture 340 to a first regular canister 30 and a second regular canister 30. The heated mixture 340 flows through the channels of canisters 30, as described earlier. Each canister 30 has a fresh water line 354 which picks up the heat from the heated mixtures in canisters 30 and exits through the second canister 30 where the fresh water line now has heated water as it travels to a source via delivery line 356 where the heated water can be utilized.

Also illustrated in FIG. 20 is the Freon line 360 which exits the compressor 18 as chilled Freon and travels via the highside/Freon (HS/Freon) line 362 to the first and second evaporator coils 370, 372 in the AC system as used in a typical AC system. The Freon is routed back to the compressor from the coils 370, 372 to be cooled and to return through the AC system. A second radiator 347 may also be incorporated into the system as shown.

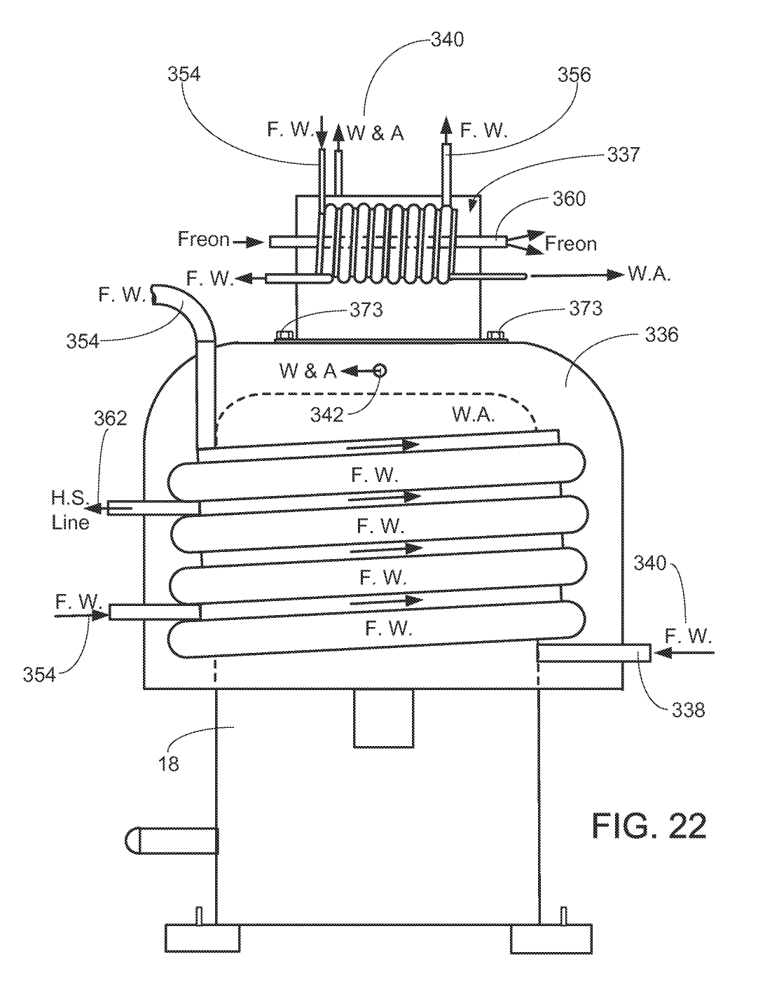

In FIGS. 21 and 22, there is illustrated the modified canister or TopHat™ canister 336 set upon compressor 18 as illustrated in FIG. 20, with the double helix channels 338, 339 operating in the same fashion as explained in regard to FIG. 20. What is changed is that there is positioned a smaller double helix canister 337 positioned on top of the modified canister 336, the smaller canister 337, in this embodiment positioned permanently as part of the modified canister 336, and also having the double helix channels 338, 339 for receiving the heated mixture 340 and heating fresh water passing through the canister 337 for use elsewhere. In FIG. 22, there is illustrated a smaller canister 337 positioned on top of the modified canister 336, which functions identically to the smaller canister 337 in FIG. 21, except that the smaller canister 337 is bolted onto the modified canister 336 via bolts 373, rather than being integral to the modified canister 336 as seen in FIG. 21.

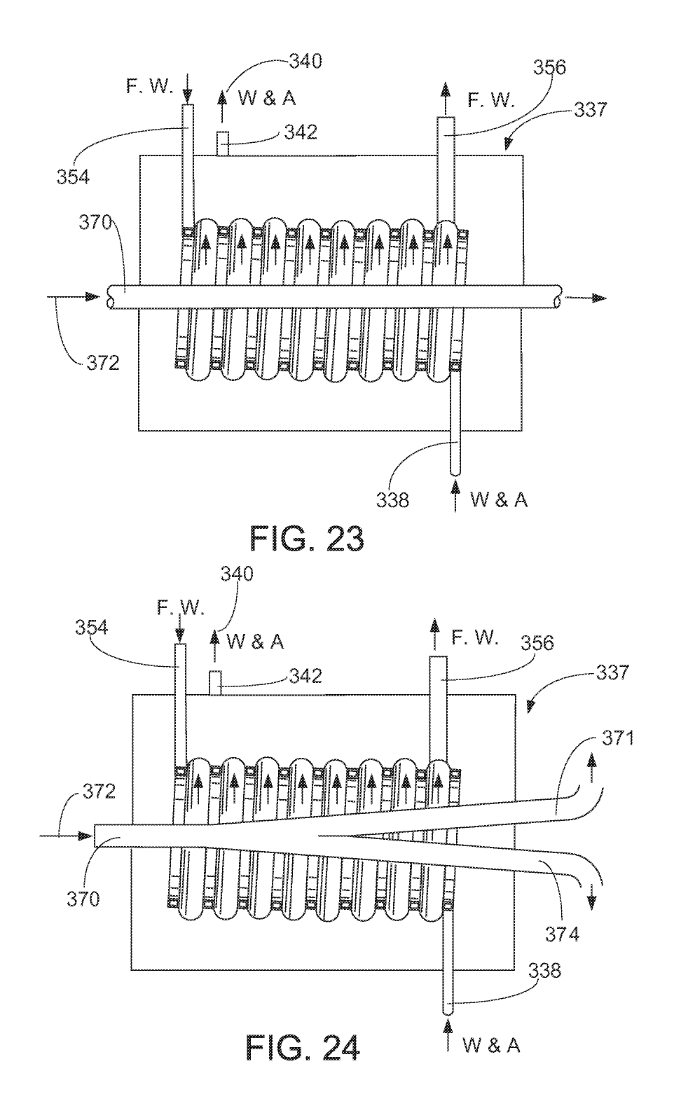

In FIGS. 23 and 24, there is illustrated a smaller modified canister 337, as described earlier, with the heated W&A mixture 340 entering through a first line 338 and exiting the canister 337 via line 342. There is provided a fresh water line 354 introducing fresh water into the canister 337. The heated mixture 340 would transfer heat to a fresh water line 354 which would exit via exit line 356, to convey the heated water to another destination. There is also illustrated a fluid line 370 to carry fluid 372 traveling through the canister 337 to pick up additional heat for delivering the heated fluid 372 to another destination. In FIG. 24, there are the same heat transfer dynamics occurring, except that the line 370 splits into two lines 371, 374 as it exits canister 337 to deliver fluid to two separate destinations.

Although FIG. 20 illustrates the modified canister 336 placed directly over the top of the compressor 18, through experimentation it has been found that there is an alternate embodiment which could be undertaken. It is known that the top of the compressor runs around 180 degrees F. (82.22 degrees Celsius) when the outside temperature is around 80 degrees F. (26.67 degrees Celsius).

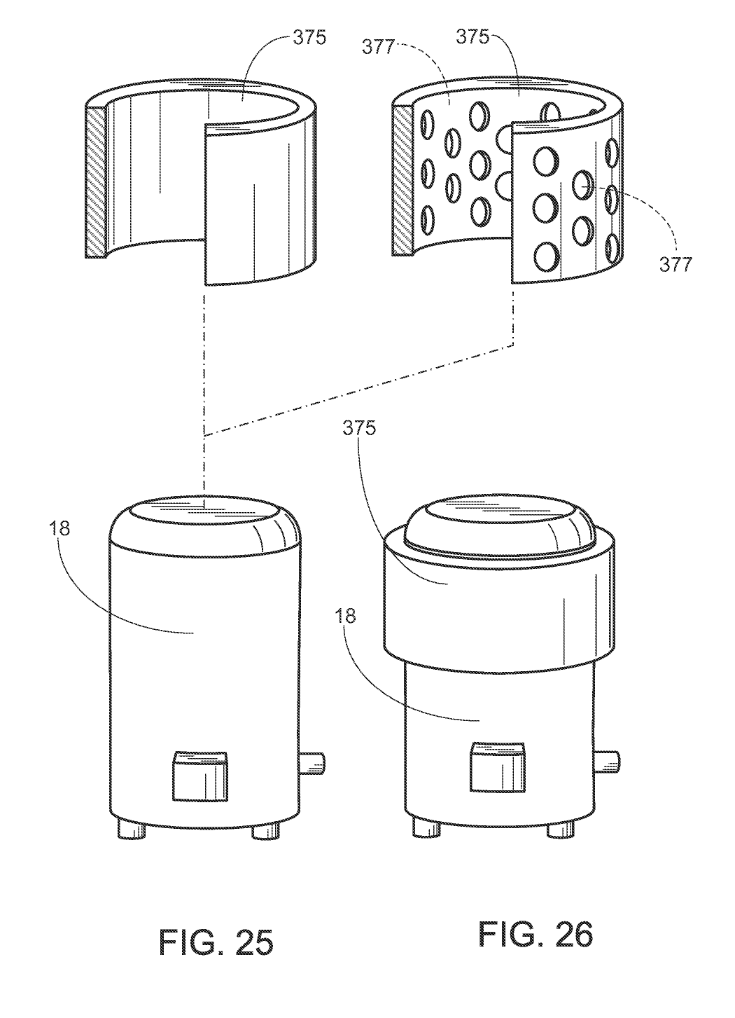

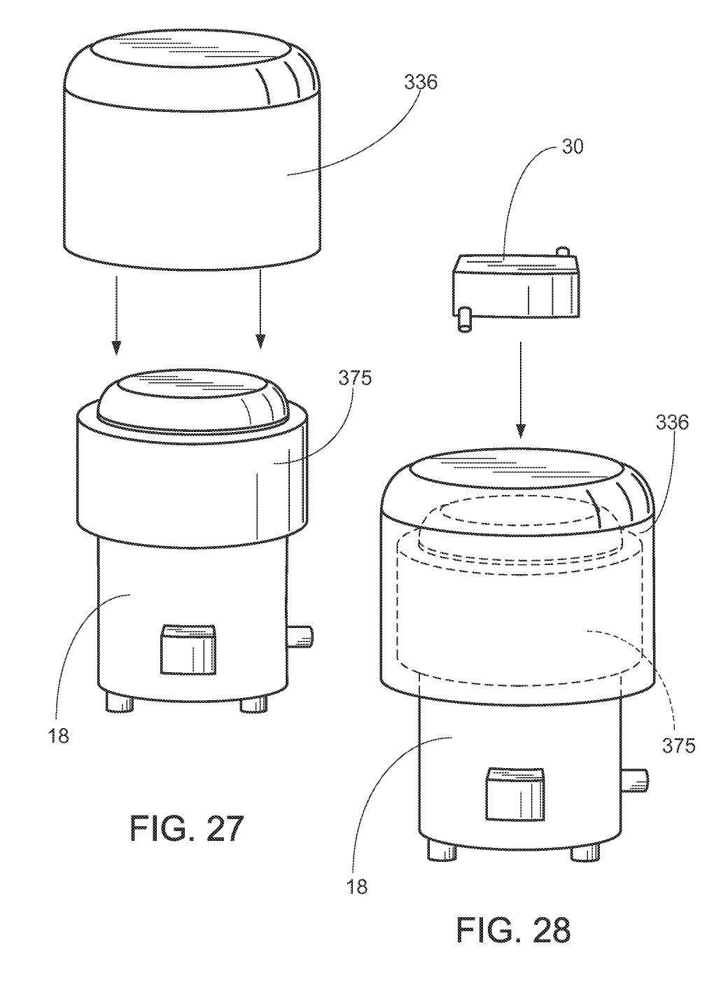

Reference is made to FIGS. 25 through 28 which illustrate an alternate embodiment of the enlarged canister 36, or the modified canister (TopHat™ canister 336) placed on the compressor 18. As seen in FIG. 25, there is illustrated a compressor 18, with a solid aluminum sleeve 375 that can be slid over the top of the compressor 18 so that the sleeve 375 would draw heat from the compressor 18, making it more efficient. In FIG. 26, there is an alternate embodiment of the sleeve 375 having a plurality of openings 377 in the sleeve 375 to further dissipate heat from the compressor 18. In FIG. 27 the sleeve 375 is set around the compressor 18, and an enlarged canister 36 or modified canister 336, would be slid and positioned over the compressor 18 as seen in FIG. 28, which also illustrates a regular canister 30 of the type described earlier, which could be set upon the enlarged canister 36, modified canister 336. The enlarged canister 36, or modified canister 336, or an aluminum coil, is set around the compressor sleeve 375 to control the temperature of the compressor 18 would allow it to run at safe conditions. Without the sleeve 375 and canister 36 or modified canister 336, a normal AC system would overload and shut off. The aluminum sleeve 375 could be sold as a kit and could be installed modified canister at the factory or just be placed over the compressor 18 with thermal paste, to reduce the possibilities of leaks. Either system would allow AC systems to run with temperatures well over 120 degrees F. (48.89 degrees Celsius) outside temperature, which would normally be unheard of in the industry.

The following is a list of parts and materials suitable for use in the present invention:

### PARTS LIST

| PART NUMBER | DESCRIPTION |
|---|---|
| 10 | primary AC system |
| 12 | exterior section |
| 14 | interior section |
| 16 | open enclosure |
| 18 | compressor |
| 20 | high side/high pressure line |
| 21 | arrows |
| 22 | condenser coils |
| 23 | arrows |
| 24 | fan |
| 25 | refrigerant/Freon ® |
| 26 | arrows |
| 27 | refrigerant (antifreeze/water) mixture |
| 28 | low side/low pressure line |
| 29 | evaporator coils |
| 30 | canister |
| 31 | first half body portion |
| 32 | arrows |
| 33 | second half body portion |
| 34 | fan |
| 35 | common surface |
| 36 | enlarged canister |
| 37 | gasket |
| 38 | inlet |
| 39 | outlet |
| 41 | first intake port |
| 43 | second outflow port |
| 44, 45 | ends |
| 46 | refrigerant line |
| 50 | secondary system |
| 53 | plastic material |
| 55 | continuous flow channel |
| 56 | air/arrows |
| 58 | pump |
| 60 | sealing members |
| 61 | arrows |
| 62 | line to radiator |
| 63 | entire border |
| 64 | dryer |
| 65 | radiator |
| 66 | line from radiator |
| 67 | line from dryer to coiled tubing |
| 68 | accumulator |
| 69 | accumulator line |
| 70 | auxiliary building (not shown) |
| 71 | line from accumulator to evaporator coils |
| 82 | main building (not shown) |
| 100 | 18 wheeler (not shown) |
| 102 | low side line |
| 104 | high side line |
| 108 | evaporator |
| 112 | dryer |
| 134 | blower |
| 136 | cool air/arrows |
| 138 | condenser |
| 200 | transformer |
| 201 | transformer mount |
| 202 | transformer enclosure |
| 204 | AC system |
| 205 | pole |
| 207 | water inline |
| 206 | water outline |
| 210 | fresh water source |
| 215 | flow line |
| 212 | flow line |
| 213 | regulating valve |
| 214 | fountain |
| 216 | Arrows |
| 217 | water filter |
| 218 | P-Trap |
| 220 | solar panel |
| 221 | canister |
| 222 | clean water flow line |
| 223 | copper lining |
| 224 | out line |
| 226 | pump |
| 230 | line |
| 232 | line |
| 240 | line |
| 242 | line |
| 250 | line |
| 300 | building |
| 336 | modified canister (TopHat ™ canister) |
| 338, 339 | double helix fluid channels |
| 340 | W&A mixture |
| 342 | first exit channel |
| 344 | first radiator |
| 346 | fan |
| 347 | second radiator |
| 348 | return line |
| 350 | pump |
| 352 | second exit channel |
| 354 | fresh water line |
| 356 | delivery line |
| 360 | water/anti-freeze line |
| 362 | highside/freon(HS/Freon) line |
| 370 | evaporator coils |
| 371 | line |
| 372 | heated fluid |
| 373 | bolts |
| 374 | line |
| 375 | aluminum sleeve |
| 377 | openings |
| 400 | section of line |

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. An energy recovery system comprising a canister mountable on a device or fluid line, the device or fluid line producing cold to an exterior of the device or fluid line, the canister comprising a body portion for encasing at least a portion of the device or fluid line in a mounted position, a fluid flow channel through the body of the canister for flowing fluid therethrough, the fluid being cooled by the cold produced by the device or fluid line, so that when the fluid exits the canister, the fluid is colder than when it entered the canister and can be circulated to another system that can utilize the cooled fluid.

2. The system in claim 1, wherein the fluid is a mixture of antifreeze and water.

3. The system in claim 1, wherein the cooled antifreeze and water can travel to an auxiliary AC system to cool air in the auxiliary system.

4. The system in claim 1, wherein the cooled fluid can be recirculated back through the system for further cooling.

5. The system in claim 2 wherein the device or fluid line may be a refrigerant line carrying cold refrigerant, for example Freon®.

6. An energy recovery system comprising a canister mountable on a device or fluid line, the device or fluid line producing heat to an exterior of the device or fluid line, the canister comprising a body portion for encasing at least a portion of the device or fluid line in a mounted position, a fluid flow channel through the body of the canister for flowing fluid therethrough, the fluid picking up the heat produced by the device or fluid line, so that when the fluid exits the canister, the fluid is hotter than when it entered the canister and can be circulated to another system that can utilize the heated fluid.

7. The system in claim 6 wherein the fluid is a mixture of antifreeze and water.

8. The system in claim 7, wherein the heated antifreeze and water can travel to a heat pump to supply additional heat to the heat pump.

9. The system in claim 6, wherein the device is a compressor of an AC system.

10. The system in claim 6 wherein the system may be used for cooling the device or fluid line, wherein when the fluid flowing through the canister picks up heat from the device, the device is cooled.

11. The system of claim 10 where the device is a compressor.

12. The system of claim 10 wherein the device is a transformer.

13. An energy recovery system in a principal cooling system, comprising:
a compressor for cooling a refrigerant to be delivered to a space for cooling the space;
a first cool refrigerant line for transporting the refrigerant from the compressor to an expansion coil to cool the space;
at least one canister positioned around at least a portion of the cool refrigerant line;
a continuous circular pathway formed within the canister;
a refrigerant mixture entering the canister and flowing through the circular pathway within the canister around a wall of the first cool refrigerant line to lower the refrigerant mixture temperature flowing from the canister to a temperature equal to or near a temperature of the first cool refrigerant line; and
a line for receiving the cooled refrigerant mixture from the canister and flowing the refrigerant mixture to cool air in a secondary expansion coil to cool a second space not being cooled by the principal cooling system.

14. The system in claim 13, wherein the canister encases a sufficient length of cool refrigerant line to allow the refrigerant mixture traveling through the circular pathway within the canister to cool the refrigerant to preferably 38 degrees F. (3.33 degrees Celsius).

15. The system in claim 13, wherein the canister is constructed of two halves which are positioned around the length of cool refrigerant line and engaged so that the refrigerant mixture fluid through the canister circular pathway does not leak from the canister as it flows therethrough.

16. The system in claim 13, wherein the canister is constructed of a heavy plastic material or some other equivalent material.

17. The system in claim 13, wherein there is further provided a set of coils for allowing the refrigerant in the principal system to cool the air in the space, and an exterior set of coils to cool the refrigerant returning from the space by ambient air flow through the coils before the refrigerant returns to the compressor.

18. The system in claim 13 wherein there may be further provided a second or more canisters on the cool refrigerant line so that the refrigerant can be cooled before it returns to the exterior coils and the compressor.

19. The system in claim 15, wherein the system may be installed in any air conditioning or heating system in a permanent structure or in moveable vehicles, such as cars, trucks, campers, 18-wheelers and the like vehicles to provide an auxiliary cooling of heating capacity.

20. The system in claim 13, wherein the canister encases a sufficient length of cool refrigerant line to allow the refrigerant mixture traveling through the circular pathway within the canister to cool the refrigerant to preferably 38 degrees F. (3.33 degrees Celsius).

21. An air conditioning system of the type having a refrigerant fluid compressor for cooling refrigerant fluid; a cooled refrigerant line for delivering cooled fluid to an expansion coil within a space, so that air blown through the coil is cooled for cooling the space; the system further comprising:
at least one energy recovery canister positioned along a portion of the cooled refrigerant line from the compressor;
a second source of a refrigerant antifreeze/water mixture flowing through the canister in circular movement around the exterior wall of the line for cooling the refrigerant mixture in the canister to essentially the same temperature as the fluid in the line as the refrigerant mixture exits the canister; and
a line leading from the canister carrying the cooled refrigerant mixture to a second expansion coil in a second space to cool air flowing through the coil in order to cool the second space.

22. The system in claim 21, wherein the line leading from the canister carrying the cooled refrigerant mixture may deliver the cooled refrigerant back to the principal air conditioning system to boost the cooling power of the system.

23. The system in claim 21, wherein the refrigerant mixture flowing through the canister comprises a mixture of antifreeze and water.

24. A system for cooling a compressor within a principal cooling system, comprising:
a compressor for cooling a first refrigerant to be delivered to a space for cooling the space;
a first cool refrigerant line for transporting the cool refrigerant from the compressor to an expansion coil to cool the space;
a canister encasing at least an outer wall of at least a portion of the compressor;
a refrigerant mixture entering the canister and flowing through the canister to lower the temperature of the compressor to reduce energy to power the compressor and to have the compressor function with increased efficiency; and
a line for flowing the refrigerant mixture from the canister to a heat exchanger, such as a radiator, to cool the refrigerant mixture in the line before it is returned to the canister surrounding the compressor.

25. The system in claim 24, wherein the canister surrounding the compressor comprises sufficient length of flow channel to allow the refrigerant mixture traveling through the canister around the compressor to receive heat from the compressor so that the compressor operates under cooler conditions.

26. The system in claim 24, wherein there is further provided a set of coils for allowing the refrigerant in the principal system to cool air in the space, and an exterior set of coils to cool the refrigerant returning from the space by ambient air flow through the coils before the refrigerant returns to the compressor.

27. The system in claim 24, wherein the system may be installed in any air-conditioning or heating system in a permanent structure or in moveable vehicles, such as cars, trucks, campers and the like vehicles to provide auxiliary cooling of heating capacity.

28. The system in claim 24, further comprising an aluminum sleeve positioned between the outer wall of the compressor and the canister to provide further cooling of the compressor during use.

29. The system in claim 28, wherein the aluminum sleeve provides a plurality of perforations through the wall to enhance the release of heat from the compressor to the canister.

30. The system in claim 24, wherein the canister surrounding a portion of the compressor comprises a double helix of fluid flow channels to allow at least two fluids to flow through the canister in separate pathways.

31. An air conditioning system having a refrigerant fluid compressor for cooling refrigerant fluid; a cooled refrigerant line for delivering the cooled refrigerant fluid to an expansion coil within a space, so that air blown through the coil is cooled for cooling the space; the system further comprising:
a canister defining a continuous channel encasing at least an outer wall of at least a portion of the compressor;
a second refrigerant mixture entering the canister and flowing through the canister to lower the temperature of the compressor to reduce the energy to power the compressor and to have the compressor function with increased efficiency; and
a line for flowing the fluid from the canister to a heat exchange means, such as a radiator, to cool the fluid in the line before it is returned to the canister surrounding the compressor.

32. The system in claim 31, wherein the refrigerant mixture flowing through the canister comprises a mixture of antifreeze and water.

33. A method of reducing heat in a device, comprising the following steps:
providing a heat exchanger, such as a canister, surrounding at least an upper portion of the device; and
flowing a volume of fluid through the canister for receiving heat from the device and thereby cooling the device.

34. The method of claim 33 wherein the device is a compressor.

35. The method of claim 33 wherein the device is a transformer.

36. The method of claim 33 further comprising a step of flowing the fluid from the heat exchanger into a second heat exchanger, such as a radiator, to remove heat from the fluid.

37. The method of claim 36 further comprising a step of returning the cooled fluid to the heat exchanger to receive additional heat from the device, on a continuing basis, so that the device operates under a cooler conditions more efficiently.

38. The method of claim 37 further comprising flowing the cooling fluid into a dryer and accumulator to further cool the fluid before it is returned to the first heat exchanger for receiving heat from the device.

39. A method of cooling a container, such as a transformer, comprising the following steps:
providing an enlarged canister encasing at least an outer wall of at least a portion of the transformer;
flowing a refrigerant mixture through the canister to receive heat from the transformer in order to lower the temperature of the transformer to have the transformer function with increased efficiency and increase the longevity of the transformer; and
flowing the refrigerant mixture from the canister to a heat exchanger, such as a radiator, to cool the refrigerant mixture in the line before it is returned to the canister surrounding the transformer.

40. The system in claim 39, wherein the refrigerant mixture flowing through the canister comprises a mixture of antifreeze and water.

41. An energy recovery system in a closed water source, such as a fountain, comprising:
a source of clean water;
a chilled water line from a principal air-conditioning system;
a first canister encasing a portion of the chilled water line;
a pathway through the first canister for allowing clean water to enter the first canister and be cooled by the chilled water line;
a flow line for carrying the chilled clean water to an end point, such as a fountain;
a second canister surrounding a drain, such as a P-trap, of the fountain;
a source of the clean water entering the second canister to be cooled by the cooled waste water in the drain, but not making contact with the waste water; and
a line to return the cooled water from the second canister to a pump for pumping the water into the clean water line to flow to the first canister.

42. The system in claim 41, wherein there is further provided a regulating valve to control the flow of clean water from the clean water source into the flow line to the first canister.

43. The system in claim 41, wherein the water flowing between the first and second canisters and the fountain defines a closed system where the water is cooled by cool water line from the air conditioning system, and does not require a second cooling source for energy saving.

44. An energy recovery system in a principal cooling system, comprising:
a compressor for cooling a first refrigerant to be delivered to a space for cooling the space;
a first cool refrigerant line for transporting the cool refrigerant from the compressor to an expansion coil to cool the space;
at least one canister positioned around at least a portion of the cool refrigerant line;
a continuous circular pathway formed within the canister;
a refrigerant mixture entering the canister and flowing through the circular pathway within the canister around an outer wall of the first cool refrigerant line to lower the temperature of the refrigerant mixture flowing from the canister to a temperature equal to or near the temperature of the first cool refrigerant line;
a first canister placed on the cool low side line from the compressor, and a second canister placed on the hot highside line, the first and second canisters receiving fluid flow from a pump, so that the flow between the canisters is a closed system for cooling the fluid flowing in the high side line from the refrigerant mixture cooled in the low side line; and
a line for receiving the cooled refrigerant mixture from the canister and flowing the refrigerant mixture to cool air in a secondary expansion coil to cool a second space not being cooled by the principal cooling system.

45. An improved cooling device, where there is provided cooled fluid flowing in a line, such as a chilled water line, comprising:
a portion of a straight flow line which has been removed;
a length of coiled flow line, so that a plurality of coils of the line define the same length as the portion of straight flow line removed;
means to splice the first and second ends of the coiled flow line into the straight flow line, so that as the chilled fluid, such as antifreeze travels, it must travel through the plurality of coils in the coiled flow line to define a greater travel area;
a canister encasing the coiled flow line; and
a water/antifreeze mixture flowing through the canister so that the flow of the water/antifreeze mixture flows along the greater travel area of a wall of the coiled flow line so that the water/antifreeze mixture receives an increased amount of cooling before the water/antifreeze exits the canister than it would have received through the straight flow line.

46. The cooling device in claim 45, wherein the canister would be provided with a continuous coiled passageway through the canister body, through which the water/antifreeze would flow, which would eliminate the need for a coiled flow line.

47. (canceled)
